(19) United States
(12) Patent Application Publication
(10) Pub. No.: US 2017/0038642 A1
(43) Pub. Date: Feb. 9, 2017

(54) ALIGNMENT LAYER AND LIQUID CRYSTAL DISPLAY INCLUDING THE SAME

(71) Applicant: Samsung Display Co., Ltd., Yongin-si (KR)

(72) Inventors: Ji Hong BAE, Yongin-si (KR); Keun Chan OH, Cheonan-si (KR)

(21) Appl. No.: 15/003,825

(22) Filed: Jan. 22, 2016

(30) Foreign Application Priority Data
Aug. 3, 2015 (KR) 10-2015-0109433

(51) Int. Cl. G02F 1/1337; C09K 19/56

(52) U.S. Cl. CPC G02F 1/133711; C09K 19/56; G02F 2001/133397

(57) ABSTRACT

An alignment layer includes at least one of photostabilizers expressed by Formula 1 and Formula 2.

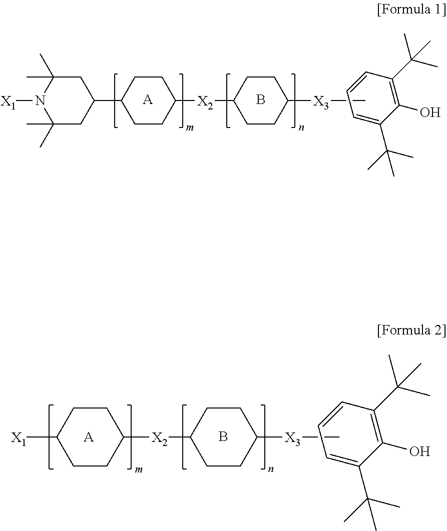

Here, X₁ is H, —OH, —OR, or R, X₂ is a bond, —O—, —OCO—, —OR—, —RO—, —NOR—, or R, X₃ is —O—, —OCO—, —OR—, —RO—, —NOR—, or R, each A and B are independently a cyclo-hexyl group, a cyclic ether group, or a phenyl group, each R is independently a C1 to C5 alkyl group, and each m and n are independently a natural number of 0 to 2.

This application claims priority to and the benefit of Korean Patent Application No. 10-2015-0109433, filed on Aug. 3, 2015, and all the benefits accruing therefrom under 35 U.S.C., the content of which in its entirety is herein incorporated by reference.

### BACKGROUND

(a) Field

The present invention relates to an alignment layer and a liquid crystal display including the same.

(b) Description of the Related Art

A liquid crystal display (LCD) is a kind of flat panel display which is widely used. The liquid crystal display includes two sheets of display panels on which electric field generating electrodes are formed, and a liquid crystal layer interposed therebetween. The direction of liquid crystal molecules in the liquid crystal layer are determined by applying a voltage to the electric field generating electrodes to generate an electric field in the liquid crystal layer, thereby adjusting transmittance of light passing through the liquid crystal layer.

Liquid crystals in the liquid crystal display play a role in achieving a desired image by controlling the transmittance of light. Particularly, depending upon the type of liquid crystal display, various characteristics such as a low voltage driving, a high voltage holding ratio (VHR), a wide viewing angle characteristic, a wide operation temperature range, a low afterimage, and a high-speed response are desired.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide an alignment layer including a photostabilizer for improving afterimage and reliability, and a liquid crystal display including the same.

An exemplary embodiment of the present invention provides an alignment layer including at least one of photostabilizers expressed by Formula 1 and Formula 2.

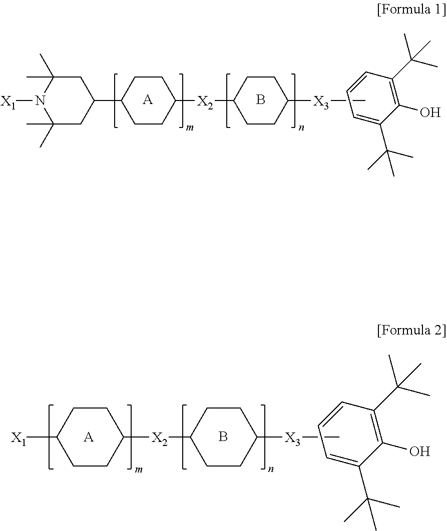

Herein, X₁ is H, —O, —OH, —OR, or R, X₂ is a bond, —O—, —OCO—, —OR—, —RO—, —NOR—, or R, X₃ is —O—, —OCO—, —OR—, —RO—, —NOR—, or R, each A and B are independently a cyclo-hexyl group, a cyclic ether group, or a phenyl group, each R is independently a C1 to C5 alkyl group, and each m and n are independently a natural number of 0 to 2.

In an exemplary embodiment, the photostabilizer expressed by Formula 1 may include at least one of compounds expressed by Formula 1-1 to Formula 1-28.

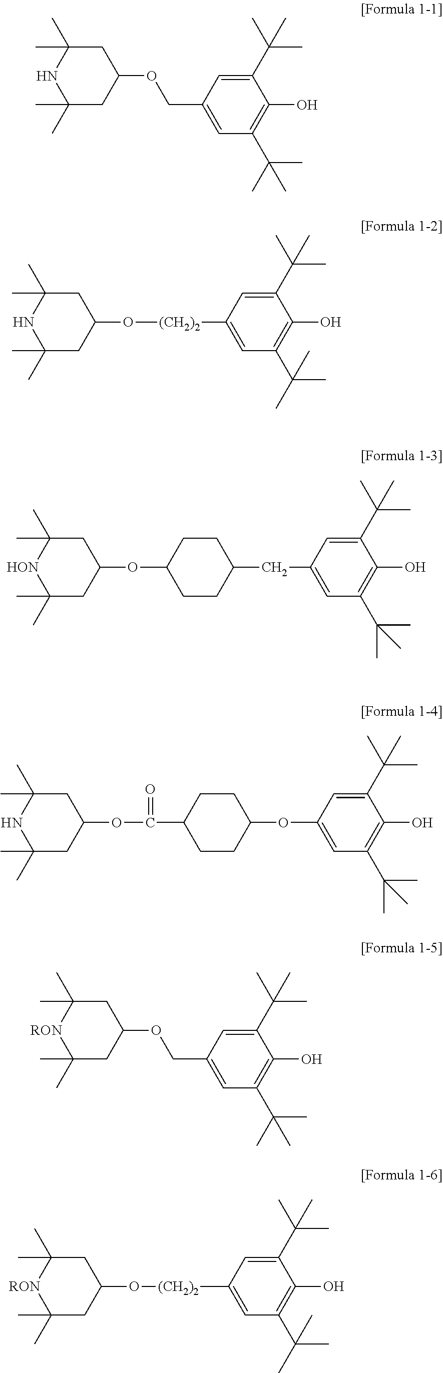

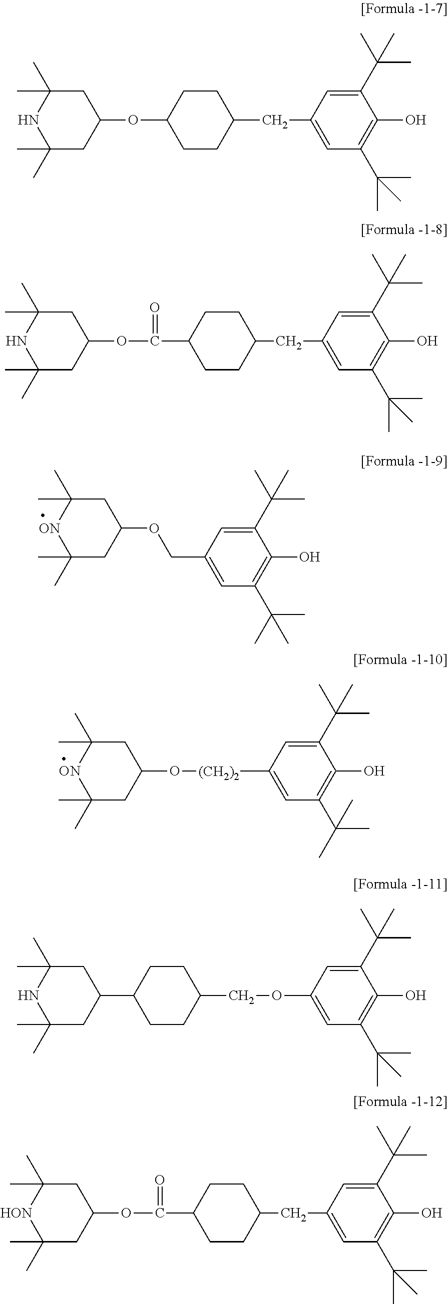

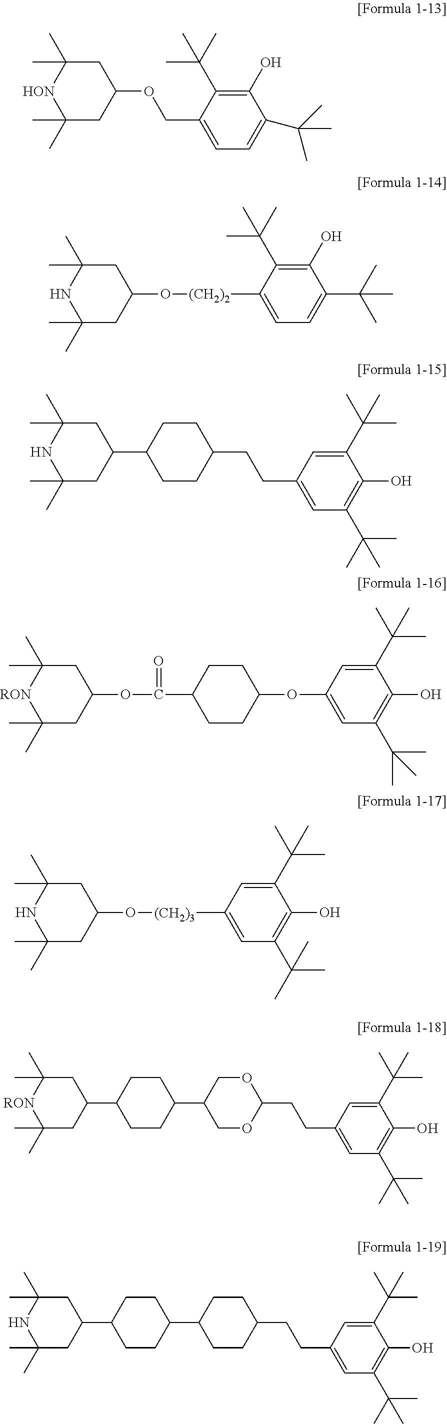

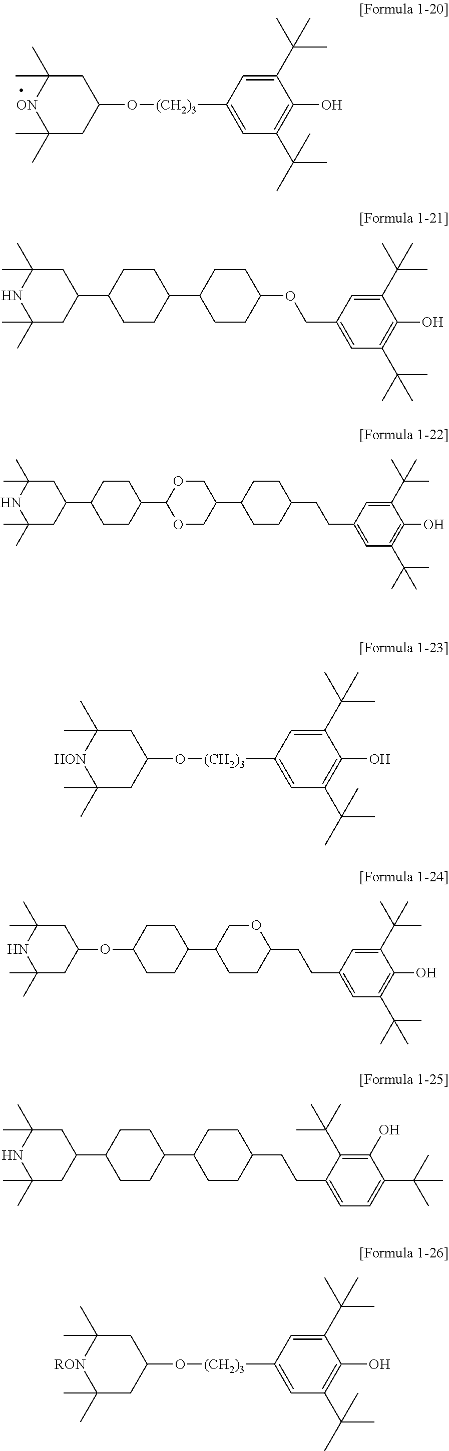

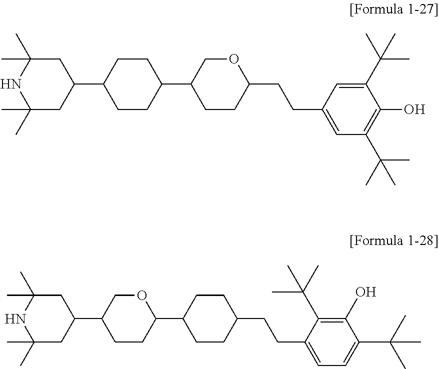

Here, each R is independently a C1 to C5 alkyl group.

In an exemplary embodiment, the photostabilizer expressed by Formula 2 may include at least one of compounds expressed by Formula 2-1 to Formula 2-16.

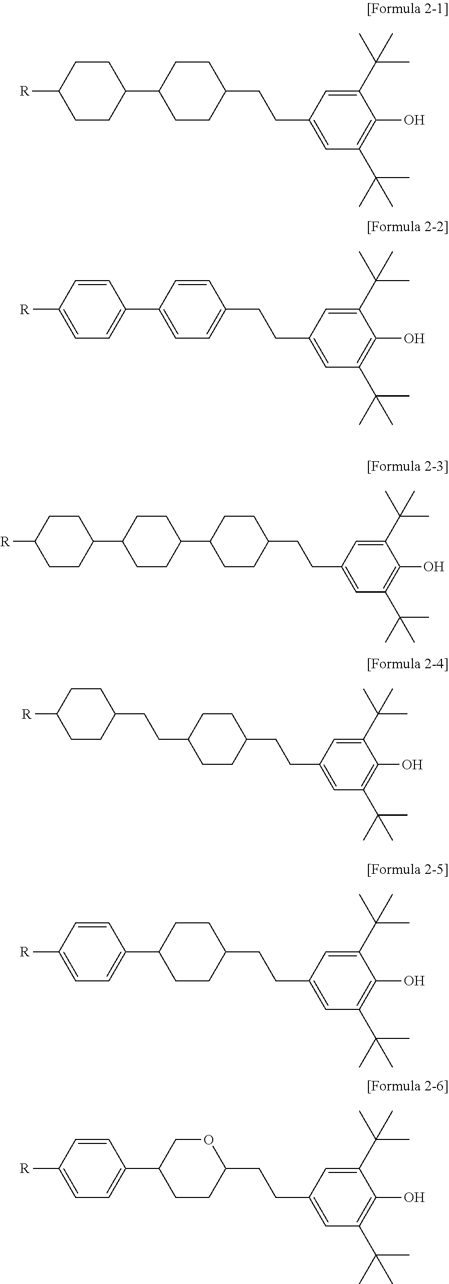

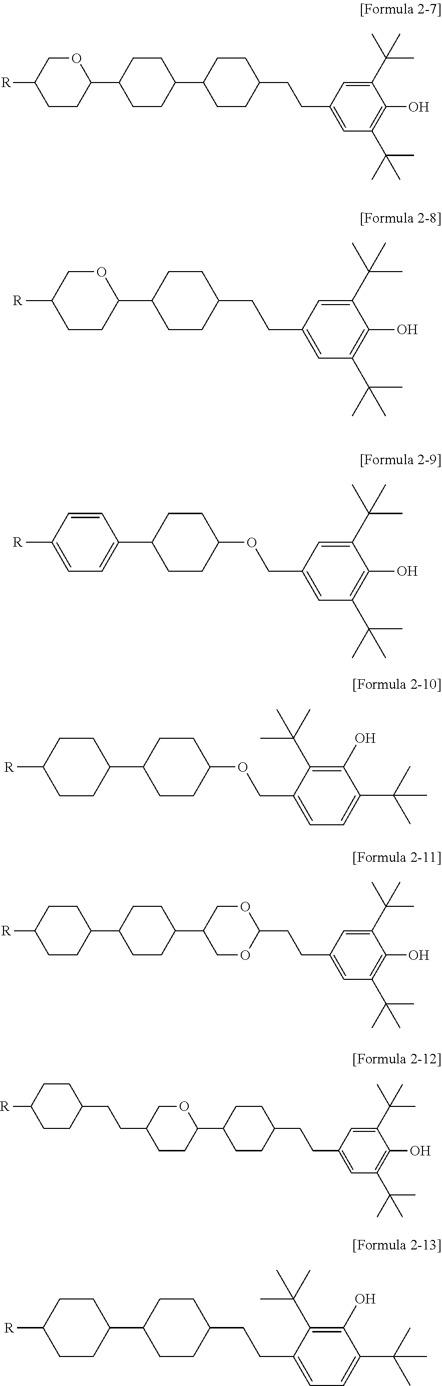

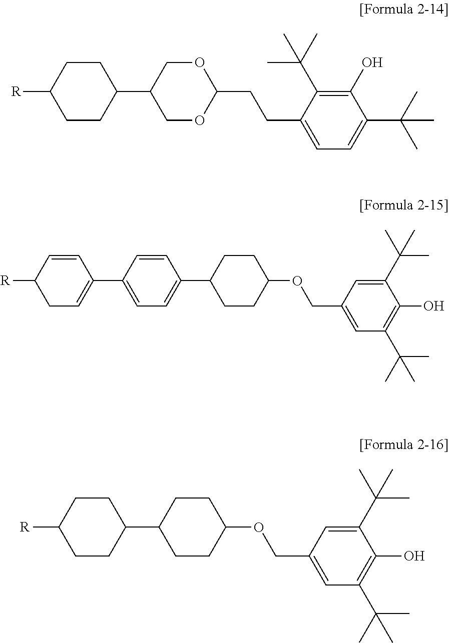

Here, each R is independently a C1 to C5 alkyl group.

In an exemplary embodiment, the alignment layer may further include a first material including a dianhydride based monomer, and a second material including a diamine based monomer.

In an exemplary embodiment, the photostabilizer may be bound to the diamine based monomer.

In an exemplary embodiment, the first material may include an alicyclic dianhydride based monomer, and the second material may include at least one of an aromatic diamine based monomer, an aliphatic ring substituted aromatic diamine based monomer, a photoreactive diamine based monomer, and an alkylated aromatic diamine based monomer.

In an exemplary embodiment, the alicyclic dianhydride based monomer may include at least one of monomers expressed by Formula 3-1 to Formula 3-5.

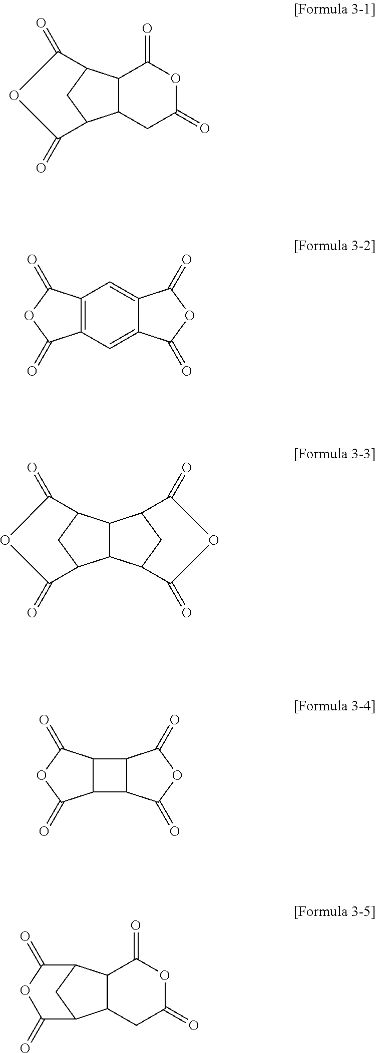 [SMILES: O=C1CC2C3CC(C(=O)OC3=O)C2C(=O)O1 ; O=c1oc(=O)c2cc3c(=O)oc(=O)c3cc12 ; O=C1OC(=O)C2CC1C1C3CC(C(=O)OC3=O)C21 ; O=C1OC(=O)C2C1C1C(=O)OC(=O)C21 ; O=C1CC2C3CC(C(=O)OC3=O)C2C(=O)O1]

Another exemplary embodiment of the present invention provides a liquid crystal display including: a first substrate; a second substrate facing the first substrate; an electric field generating electrode disposed on at least one of the first substrate and the second substrate; a first alignment layer disposed on the first substrate and a second alignment layer disposed on the second substrate; and a liquid crystal layer including a plurality of liquid crystal molecules and disposed between the first substrate and the second substrate, wherein at least one of the first alignment layer and the second alignment layer includes at least one of photostabilizers expressed by Formula 1 and Formula 2.

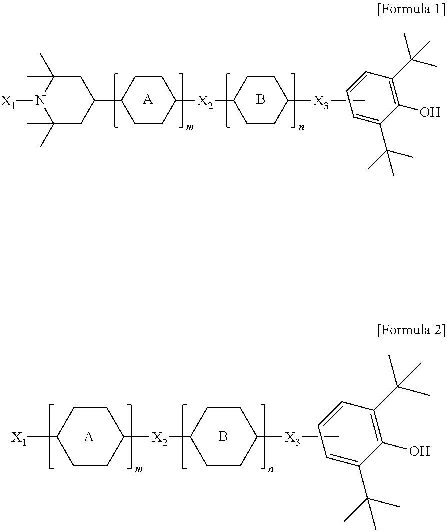

Here, X₁ is H, —O, —OH, —OR, or R, X₂ is a bond, —O—, —OCO—, —OR—, —RO—, —NOR—, or R, X₃ is —O—, —OCO—, —OR—, —RO—, —NOR—, or R, each A and B are independently a cyclo-hexyl group, a cyclic ether group, or a phenyl group, each R is independently a C1 to C5 alkyl group, and each m and n are independently a natural number of 0 to 2.

In an exemplary embodiment, the liquid crystal molecules may include an alkenyl group.

In an exemplary embodiment, the liquid crystal molecules may include at least one of compounds expressed by Formula 8-1 to Formula 8-16.

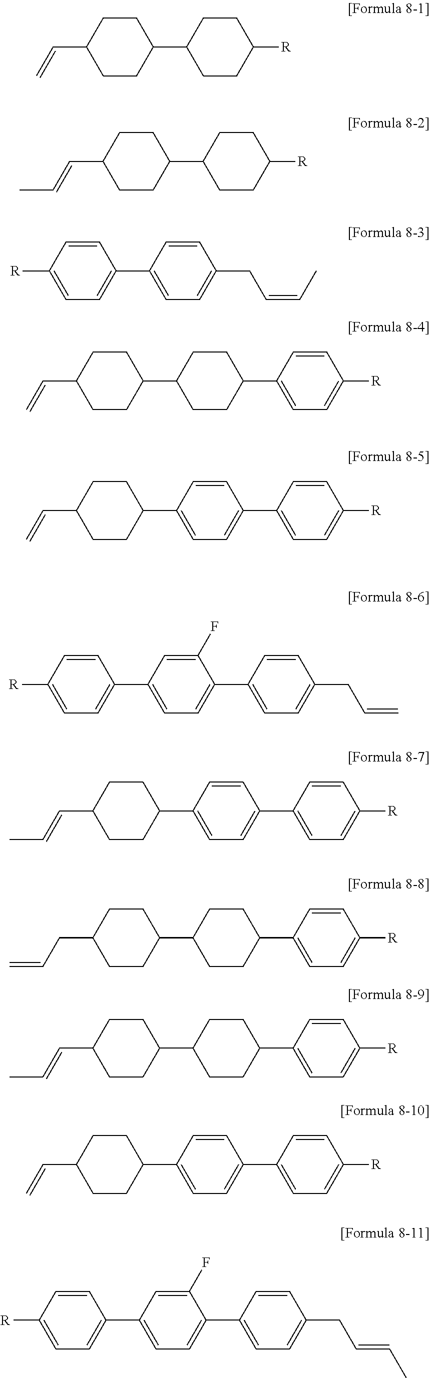

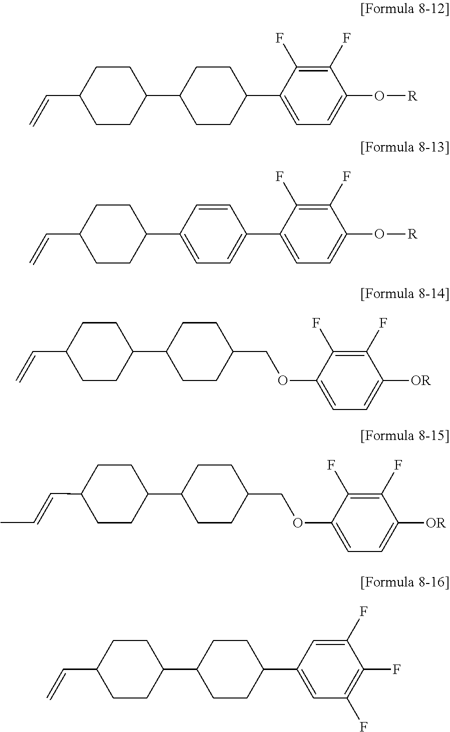

Here, each R is independently a C1 to C5 alkyl group.

According to exemplary embodiments, regarding the alignment layer and the liquid crystal display including the same, the alignment layer includes a new photostabilizer to prevent generation of an impurity in the liquid crystal layer and thereby improve both the afterimage that may be generated in the display panel and increase reliability.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is an equivalent circuit diagram of a pixel of an exemplary embodiment of a liquid crystal display.

FIG. 2 is a plan view of an exemplary embodiment of a liquid crystal display according.

FIG. 3 is a cross-sectional view with respect to line III-III of FIG. 2.

FIG. 4 is a graph illustrating the variation in voltage holding ratio with the fluorescent exposure time (0, 40, 60, or 100 minutes(min)) for liquid crystal displays in accordance with Examples 1 and 2 and Comparative Examples 1 to 3.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top.” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

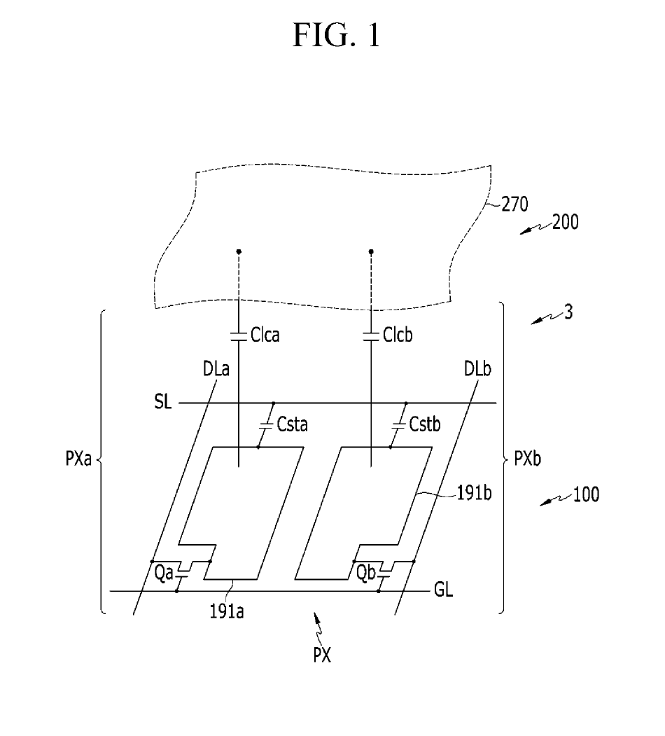

An exemplary embodiment of a liquid crystal display will now be described with reference to FIG. 1 to FIG. 3.

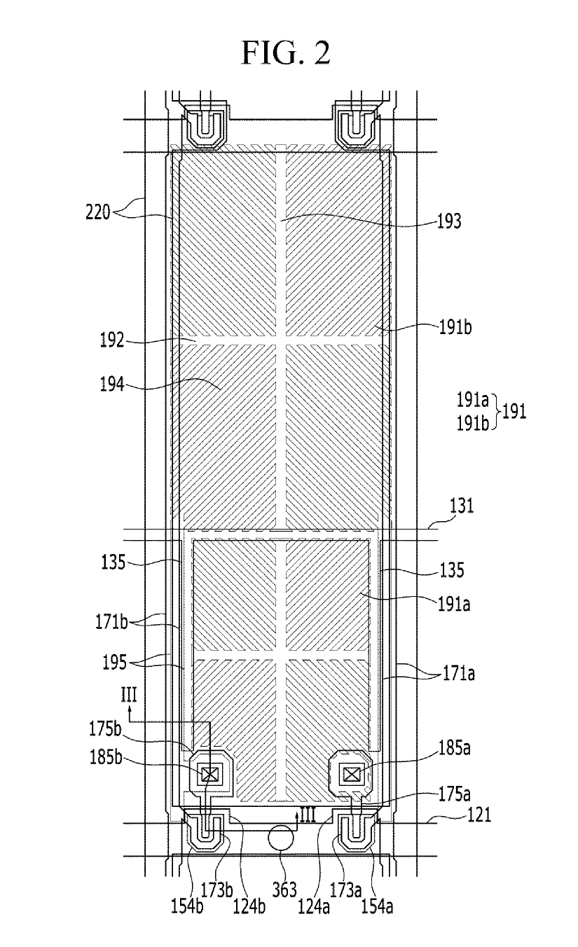

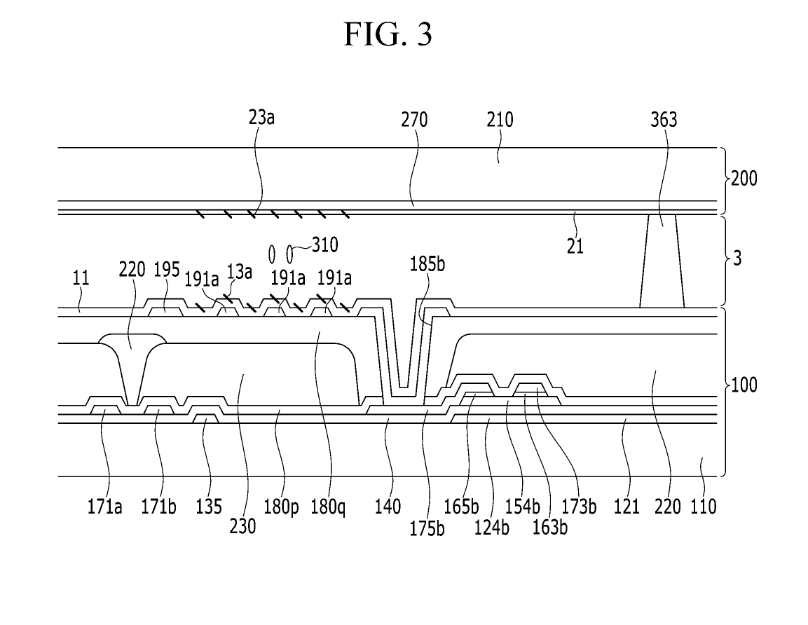

FIG. 1 shows an equivalent circuit diagram of a pixel of an exemplary embodiment of a liquid crystal display, FIG. 2 is a plan view of an exemplary embodiment of a liquid crystal display, and FIG. 3 is a cross-sectional view with respect to line III-III of FIG. 2.

Referring to FIG. 1, the exemplary liquid crystal display includes a lower panel 100 and an upper panel 200 facing each other, and a liquid crystal layer 3 provided therebetween.

The liquid crystal display includes signal lines including a plurality of gate lines GL, a plurality of pairs of data lines DLa, DLb, and a plurality of storage electrode lines SL, and a plurality of pixels PX connected thereto.

Each pixel PX includes a pair of subpixels PXa, PXb, and the subpixels PXa, PXb include switching elements Qa, Qb, liquid crystal capacitors Clca, Clcb, and storage capacitors Csta, Cstb.

The switching elements Qa, Qb are three-terminal elements, such as thin film transistors, provided on the lower panel 100, of which a control terminal is connected to the gate line GL, an input terminal is connected to the data lines DLa, DLb, an output terminal is connected to the liquid crystal capacitors Clca, Clcb and the storage capacitors Csta. Cstb.

The liquid crystal capacitors Clca, Clcb are formed by having subpixel electrodes 191a and 191b and a common electrode 270 as two terminals, with a liquid crystal layer 3 between the two terminals as a dielectric material.

The storage capacitors Csta, Cstb for supporting the liquid crystal capacitors Clca. Clcb are formed when the storage electrode lines SL provided on the lower panel 100 overlap the subpixel electrodes 191a and 191b with an insulator therebetween. The storage electrode lines SL receive a predetermined voltage such as a common voltage (Vcom).

Voltages charged in the liquid crystal capacitors Clca, Clcb are set to have a slight difference. For example, a data voltage applied to the liquid crystal capacitor Clca is set to always be greater or lesser than a data voltage applied to the neighboring liquid crystal capacitor Clcb. When the voltages at the liquid crystal capacitors Clca, Clcb are appropriately controlled, an image seen from a lateral side may approach an image seen from a front side thereby improving lateral visibility of the liquid crystal display.

An exemplary embodiment of a liquid crystal display will now be described with reference to FIG. 2 and FIG. 3.

Referring to FIG. 2 and FIG. 3, the liquid crystal display includes a lower panel 100 and an upper panel 200 facing each other, and a liquid crystal layer 3 provided between the display panels 100 and 200.

The lower panel 100 will now be described.

A plurality of gate lines 121 and a plurality of storage electrode lines 131 and 135 are formed on an insulation substrate 110.

The gate lines 121 transmit gate signals and mainly extend in a horizontal direction. Each gate line 121 includes a plurality of first and second gate electrodes 124a and 124b protruded upward.

The storage electrode lines include a stem line 131 extending substantially in parallel to the gate lines 121, and storage electrodes 135 extending from the stem line 131. Forms and dispositions of the storage electrode lines 131 and 135 are variable in many ways.

The gate lines 121 and the storage electrode lines 135 may be made of at least one metal selected from a group consisting of an aluminum-based metal such as aluminum (Al) and an aluminum alloy, a silver-based metal such as silver (Ag) and a silver alloy, and a copper-based metal such as copper (Cu) and a copper alloy.

The gate lines 121 and the gate electrodes 124a and 124b are formed by a single film, but are not limited thereto and may be formed in a dual-film or triple-film pattern.

When the gate lines 121 and the gate electrodes 124a and 124b have a dual-film structure, they may be include a lower film and an upper film. The lower film may be include at least one metal selected from a group consisting of a molybdenum-based metal such as molybdenum (Mo), a molybdenum alloy, chromium (Cr), a chromium alloy, titanium (Ti), a titanium alloy, tantalum (Ta), a tantalum alloy, manganese (Mn), and a manganese alloy. The upper film may include at least one metal selected from a group consisting of an aluminum-based metal such as aluminum (Al) and an aluminum alloy, a silver-based metal such as silver (Ag) and a silver alloy, and a copper-based metal such as copper (Cu) and a copper alloy. In the case of a triple-film structure, films having different physical properties may be combined to be formed.

A gate insulating layer 140 is formed on the gate lines 121 and the storage electrode lines 131 and 135, and a plurality of semiconductor layers 154a and 154b made of amorphous silicon or crystalline silicon are formed on the gate insulating layer 140.

A plurality of pairs of ohmic contacts 163b and 165b are formed on the semiconductor layers 154a and 154b, and they may be made of a material such as n+ hydrogenated amorphous silicon in which an n-type impurity is doped with a high concentration, or of a silicide.

A plurality of pairs of data lines 171a and 171b and a plurality of pairs of first and second drain electrodes 175a and 175b are formed on the ohmic contacts 163b and 165b and the gate insulating layer 140.

The data lines 171a and 171b transmit a data signal and mainly extend in a perpendicular direction to cross the gate line 121 and the stem line 131 of the storage electrode line. The data lines 171a and 171b include first and second source electrodes 173a and 173b extending toward the first and second gate electrodes 124a and 124b and bent in a U shape. The first and second source electrodes 173a and 173b face the first and second drain electrodes 175a and 175b with respect to the first and second gate electrodes 124a and 124b.

The data lines 171a and 171b may be made of at least one metal selected from a group consisting of an aluminum-based metal such as aluminum (Al) and an aluminum alloy, a silver-based metal such as silver (Ag) and a silver alloy, and a copper-based metal such as copper (Cu) and a copper alloy. In an exemplary embodiment, the data lines 171a and 171b are formed as a single film. In alternative embodiments, the data lines 171a and 171b may be formed as a dual-film or triple-film pattern.

The first and second drain electrodes 175a and 175b extend upward at one end partly surrounded by the first and second source electrodes 173a and 173b, and another end may be large enough to access another layer.

However, the shapes and dispositions of the data lines 171a and 171b, in addition to the first and second drain electrodes 175a and 175b, are not limited and may be modified in many ways.

The first and second gate electrodes 124a and 124b, the first and second source electrodes 173a and 173b, and the first and second drain electrodes 175a and 175b form the first and second thin-film transistors together with the first and second semiconductor layers 154a and 154b. Channels of the first and second thin-film transistors are formed on the first and second semiconductor layers 154a and 154b between the first and second source electrodes 173a and 173b and the first and second drain electrodes 175a and 175b.

The ohmic contacts 163b and 165b are provided between the semiconductor layers 154a and 154b which are below them and the data lines 171a and 171b and the drain electrodes 175a and 175b which are above them, and reduce contact resistance therebetween. Portions that are exposed and are not covered by the data lines 171a and 171b and the drain electrodes 175a and 175b are provided between the source electrodes 173a and 173b and the drain electrodes 175a and 175b on the semiconductor layers 154a and 154b.

A lower passivation layer 180p made of a silicon nitride or a silicon oxide is formed on the data lines 171a and 171b, the drain electrodes 175a and 175b, and the exposed semiconductor layers 154a and 154b.

A color filter 230 is formed on the lower passivation layer 180p. The color filter 230 may include color filters of red, green, and blue. A light blocking member 220 made of a single layer or dual layers of chromium and a chromium oxide, or an organic material, is formed on the color filter 230. The light blocking member 220 may have an opening arranged in a matrix form.

An upper passivation layer 180q made of a transparent organic insulating material is formed on the color filter 230 and the light blocking member 220. The upper passivation layer 180q prevents the color filter 230 from being exposed and provides a flat surface. A plurality of contact holes 185a and 185b are formed in the upper passivation layer 180q, and expose the first and second drain electrodes 175a and 175b.

A plurality of pixel electrodes 191 are formed on the upper passivation layer 180q. The pixel electrode 191 may be made of a transparent conductive material such as indium tin oxide (ITO) or indium zinc oxide (IZO), or a reflective metal such as aluminum, silver, chromium, or an alloy thereof.

The pixel electrode 191 includes first and second sub-pixel electrodes 191a and 191b separated from each other. The first and second sub-pixel electrodes 191a and 191b respectively include a cross-shaped stem configured with a horizontal stem 192 and a perpendicular stem 193 crossing the same, and includes a fine branch 194 extending from the horizontal stem 192 and the perpendicular stem 193 in an oblique manner.

A first alignment layer 11 is formed on an inner surface of the lower panel 100, and the first alignment layer 11 may be a vertical alignment layer. The first alignment layer 11 includes a first alignment polymer 13a formed by irradiation of light onto an alignment aid. The alignment aid may be a reactive mesogen. When a first alignment material is applied to the lower panel 100 to form the first alignment layer 11, the alignment aid may be mixed with the first alignment material and then be applied to the lower panel 100.

In an exemplary embodiment, the first alignment layer 11 may include a dianhydride-based monomer, a diamine-based monomer, and a photostabilizer covalently bound to the diamine.

In one embodiment, the dianhydride-based monomer may include an alicyclic dianhydride based monomer. In another embodiment, the dianhydride-based monomer may include at least one of an aromatic diamine based monomer, an aliphatic ring substituted aromatic diamine based monomer, a photo-reactive diamine based monomer, and an alkylated aromatic diamine based monomer.

In an exemplary embodiment, the photostabilizer included in the first alignment layer 11 includes at least one of compounds expressed in Formula 1 and Formula 2.

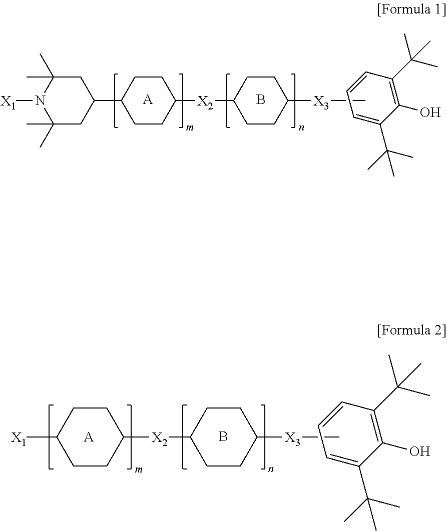

Here, X₁ is H, —OH, —OR, or R, X₂ is a bond, —O—, —OCO—, —OR—, —RO—, —NOR—, or R, X₃ is —O—, —OCO—, —OR—, —RO—, —NOR—, or R, each A and B independently include a cyclo-hexyl group, a cyclic ether group, or a phenyl group, each R is independently a C1 to C5 alkyl group, and each m and n are independently a natural number of 0 to 2.

The X₃ group may be attached to the para or meta position of the phenol group in Formula 1 and Formula 2, and in Formula 1, the photostabilizer includes a cycloamine group on the opposite side of the structure.

In an exemplary embodiment, the compound expressed by Formula 1 may be at least one of Formula 1-1 to Formula 1-28.

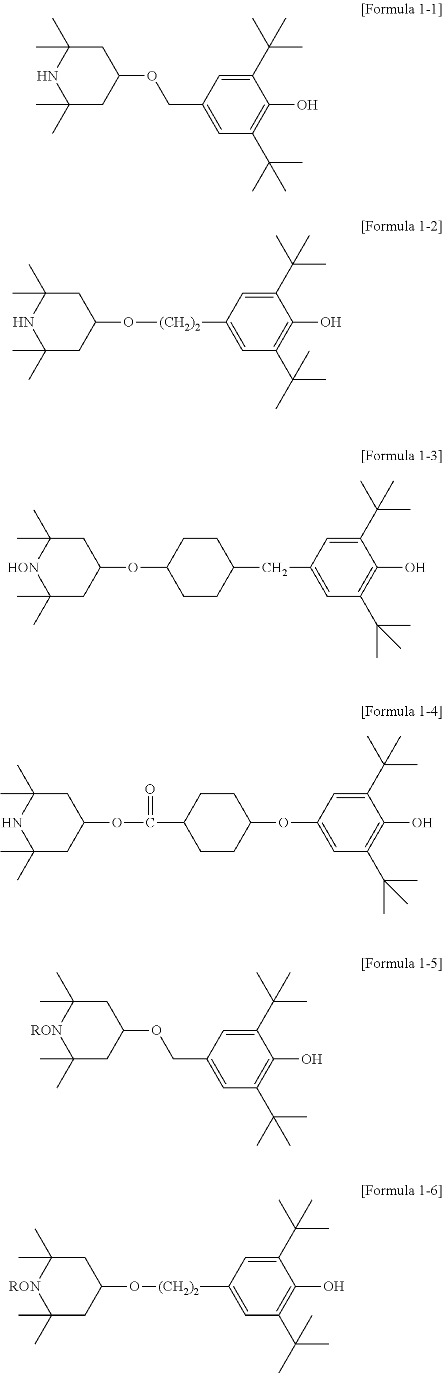

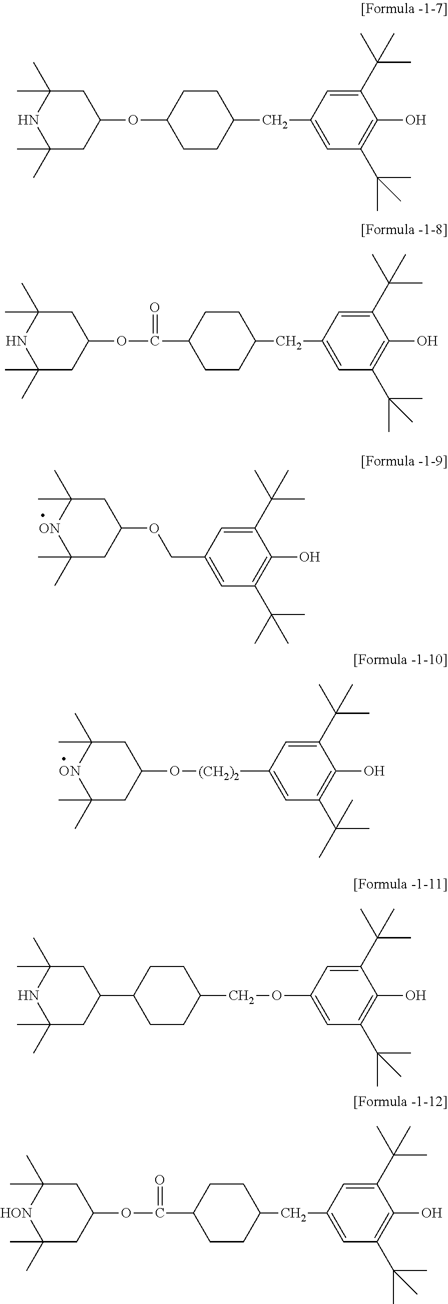

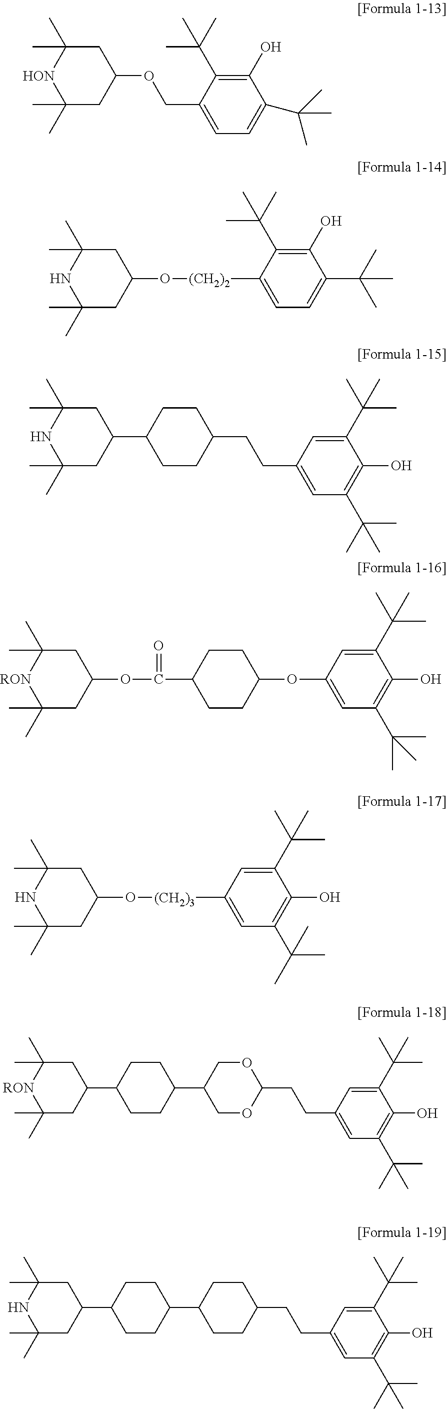

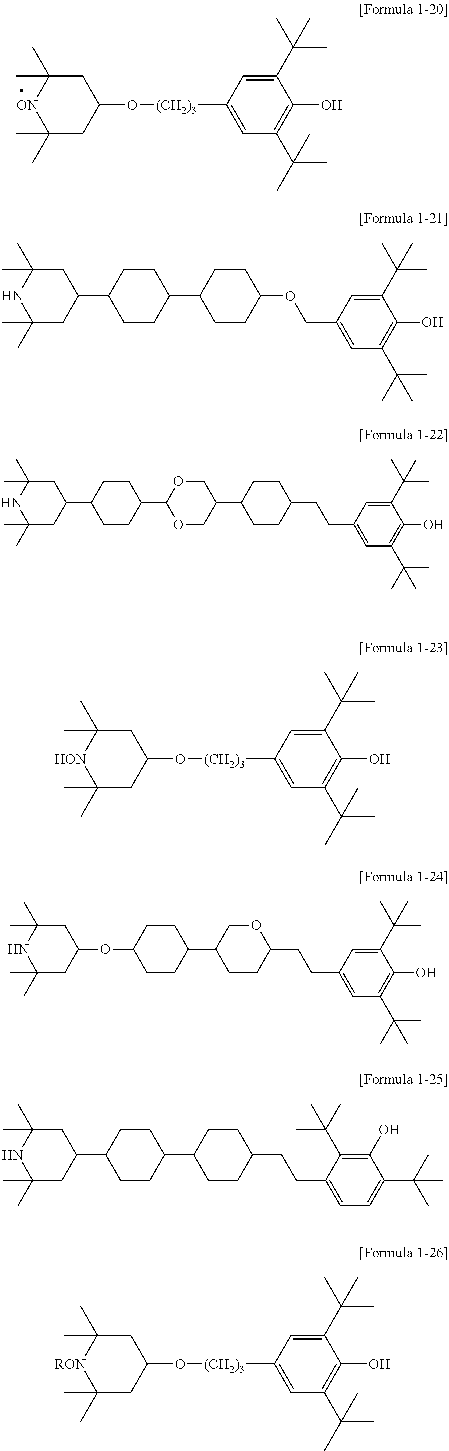

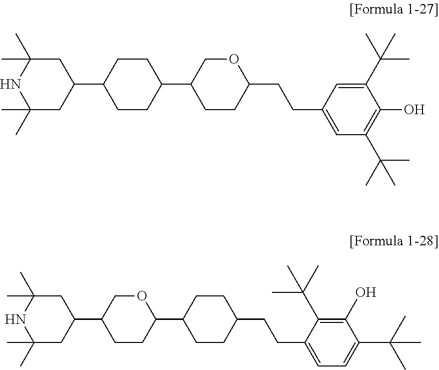

In the above Formulas 1-1 to 1-28, each R is independently a C1 to C5 alkyl group.

In an exemplary embodiment, the compound expressed by Formula 2 may be at least one of Formula 2-1 to Formula 2-16.

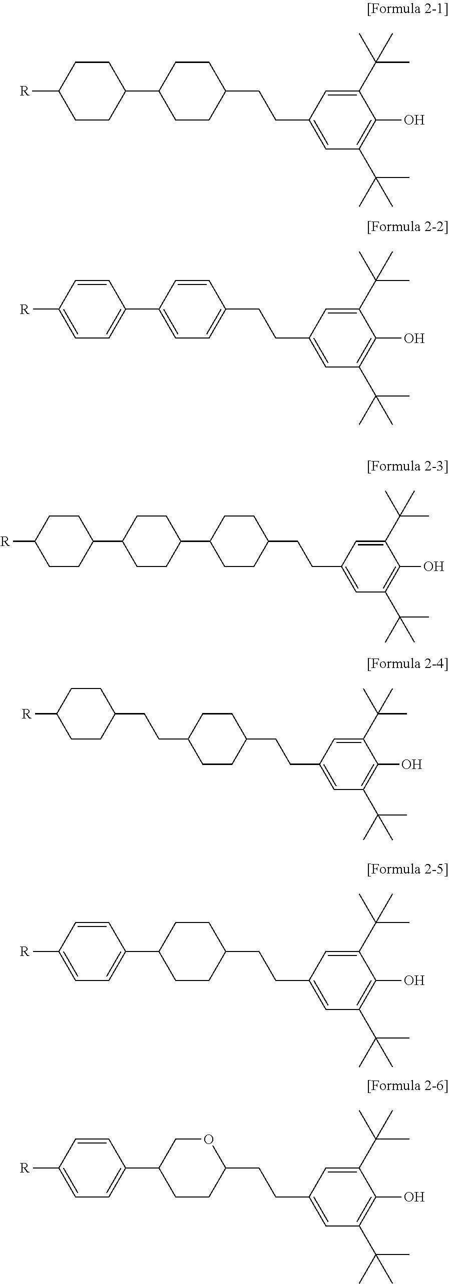

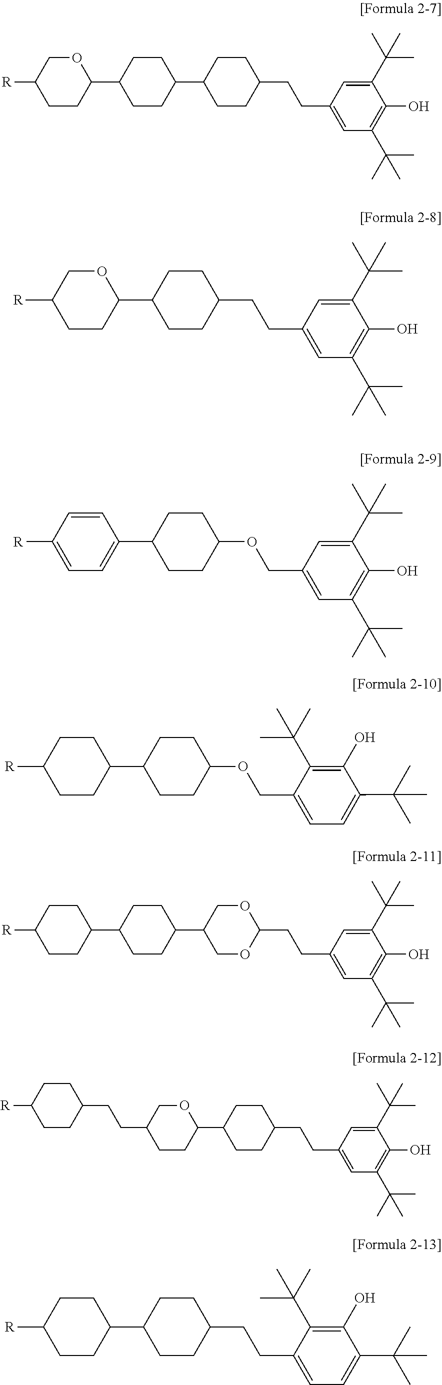

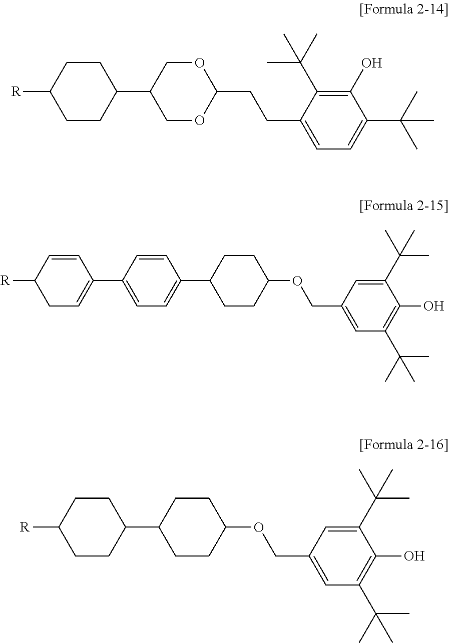

In the above Formulas 2-1 to 2-16, each R is independently a C1 to C5 alkyl group

The compounds represented by Formula 1 and Formula 2 control the reactivity of the liquid crystal molecules in the presence of UV or heat, and thus may improve the reliability of a liquid crystal composition

In an exemplary embodiment, the compounds expressed by Formula 1 and Formula 2 are included in the alignment layer as a photostabilizer so that the stability of the liquid crystals in the liquid crystal layer may be improved as compared to the case of including the photostabilizer in the liquid crystal composition.

The synthesis of the compound expressed by Formula 1-1 will now be described as an example for the synthesis the compound of Formula 1.

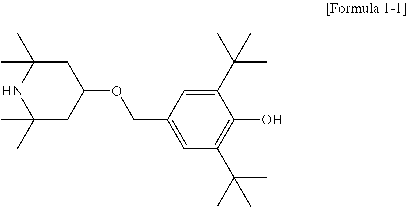 [SMILES: CC1(C)CC(OCc2cc(C(C)(C)C)c(O)c(C(C)(C)C)c2)CC(C)(C)N1]

Regarding Formula 1-1, as shown in Reaction Equation 1, the compound 1-A is first synthesized under predetermined conditions.

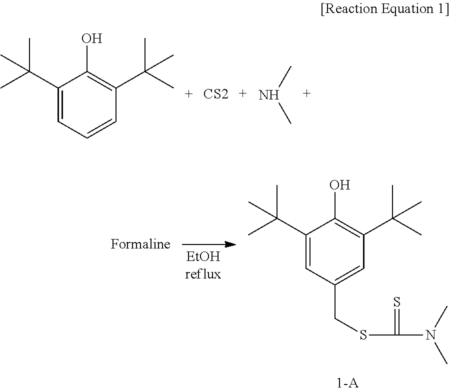

In an exemplary embodiment, the compound 1-A synthesized in Reaction Equation 1 is reacted under the conditions as shown in Reaction Equation 2 to synthesize the compound of Formula 1—.

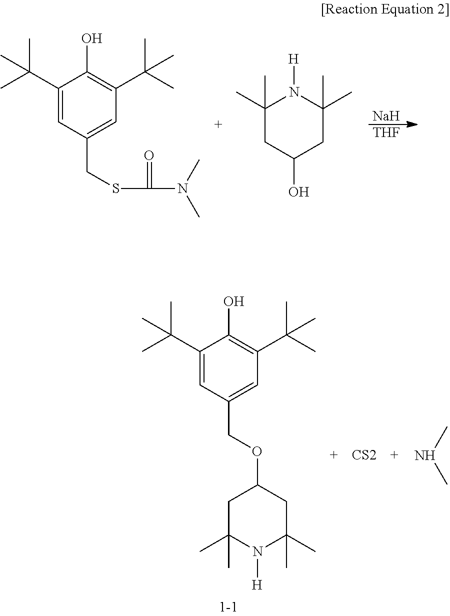

The synthesis of the compound expressed by Formula 1-15 will now be described as an exemplary embodiment of the synthesis compound expressed in Formula 1.

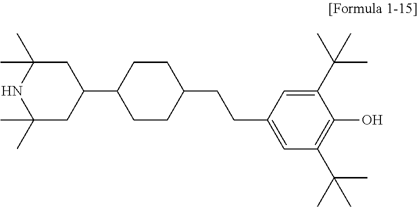 [SMILES: CC1(C)CC(C2CCC(CCc3cc(C(C)(C)C)c(O)c(C(C)(C)C)c3)CC2)CC(C)(C)N1]

The compound 1-15A is synthesized through Reaction Equation 3, and a compound 1-15B is further synthesized as expressed in Reaction Equation 4.

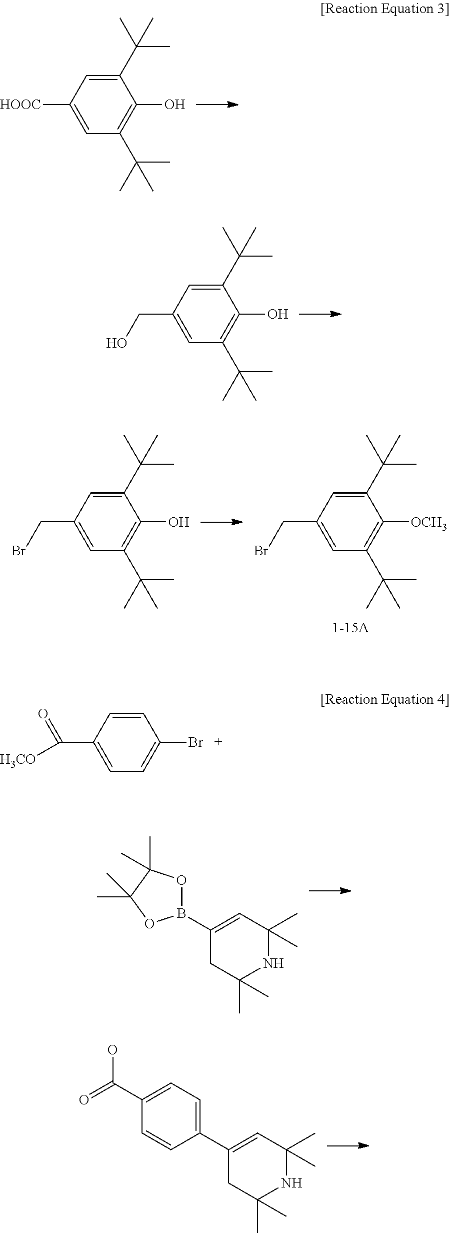

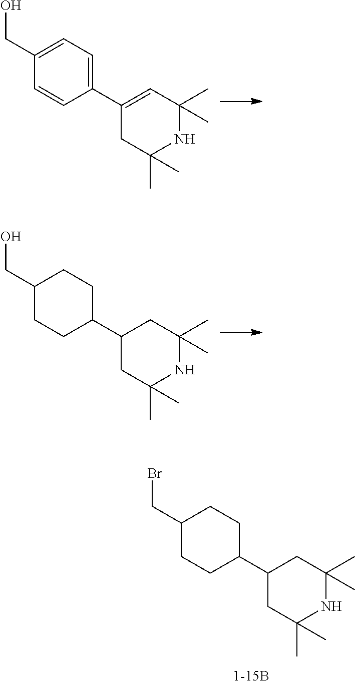 [SMILES: CC1(C)C=C(c2ccc(CO)cc2)CC(C)(C)N1 ; CC1(C)CC(C2CCC(CO)CC2)CC(C)(C)N1 ; CC1(C)CC(C2CCC(CBr)CC2)CC(C)(C)N1]

The synthesized compound 1-15A and the compound 1-15B are synthesized as shown in Reaction Equation 5 to prepare the compound expressed in Formula 1-15.

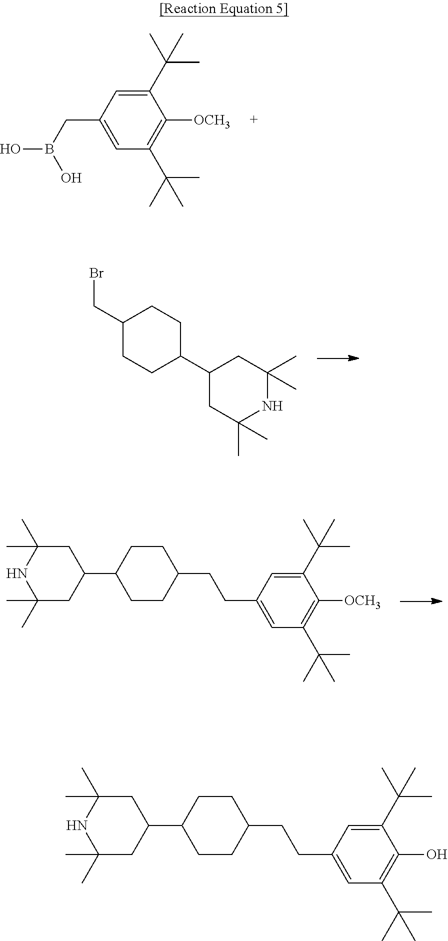 [SMILES: COc1c(C(C)(C)C)cc(CB(O)O)cc1C(C)(C)C ; "+" ; CC1(C)CC(C2CCC(CBr)CC2)CC(C)(C)N1 ; COc1c(C(C)(C)C)cc(CCC2CCC(C3CC(C)(C)NC(C)(C)C3)CC2)cc1C(C)(C)C ; CC1(C)CC(C2CCC(CCc3cc(C(C)(C)C)c(O)c(C(C)(C)C)c3)CC2)CC(C)(C)N1]

The synthesis of the compound expressed by Formula 2-1 will now be described as an exemplary embodiment of the synthesis of the compound expressed in Formula 2.

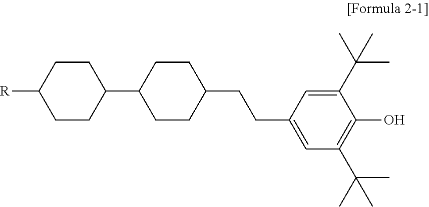

The compound 2-1A is first synthesized through the process of Reaction Equation 6, and the compound 2-1B is synthesized through the process of Reaction Equation 7.

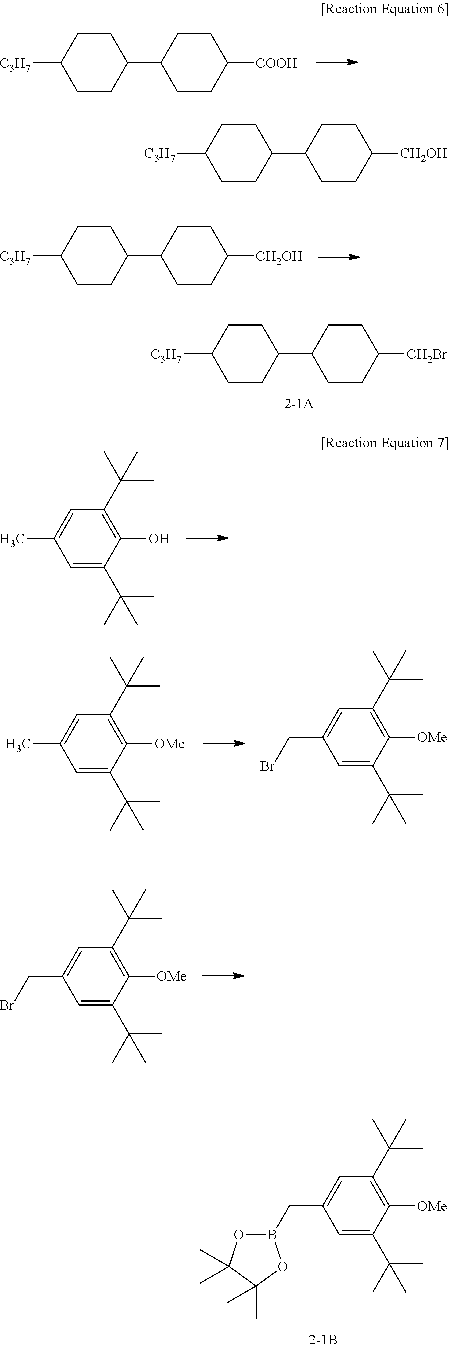

The compound 2-1A and the compound 2-1B synthesized through Reaction Equation 6 and Reaction Equation 7 are reacted in Reaction Equation 8 to synthesize the compound expressed in Formula 2-1.

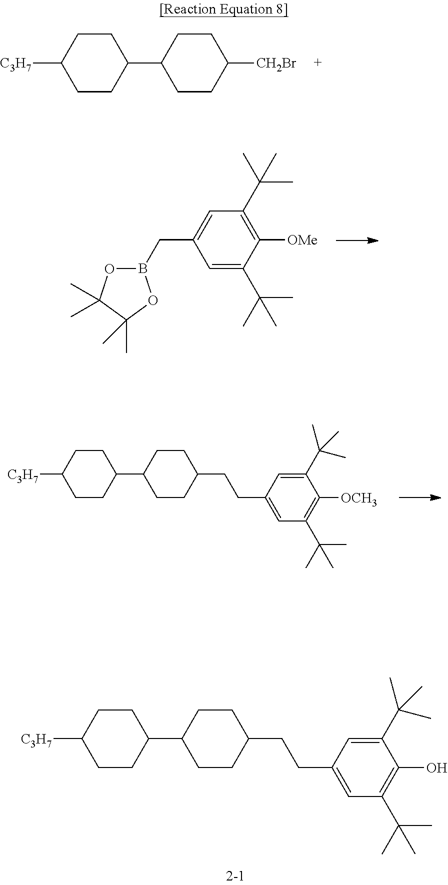

The above-described reaction equations or synthesis methods are provided as exemplary embodiments of methods to synthesize the photostabilizer, but are not limited thereto, and any methods for synthesizing the compounds expressed by Formulae 1 to 2 may be used.

An alicyclic dianhydride based monomer may be a monomer having a structure expressed as one of Formula 3-1 to Formula 3-5 on a dianhydride basis.

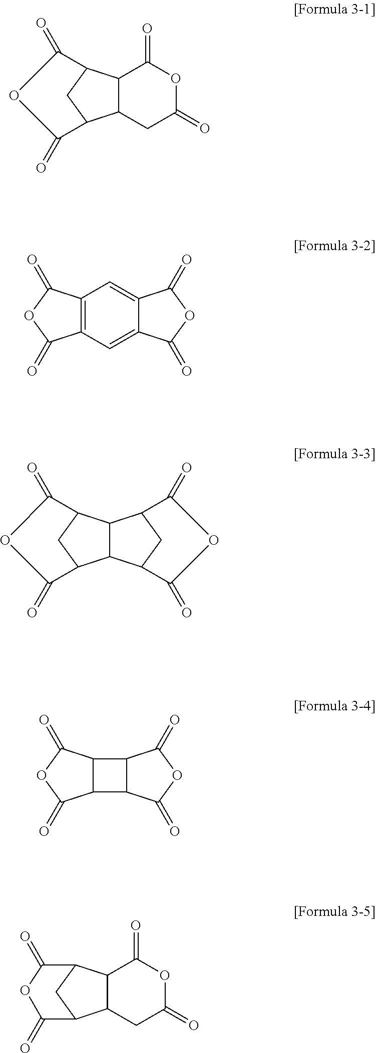 [SMILES: O=C1CC2C3CC(C(=O)OC3=O)C2C(=O)O1 ; O=c1oc(=O)c2cc3c(=O)oc(=O)c3cc12 ; O=C1OC(=O)C2CC1C1C3CC(C(=O)OC3=O)C21 ; O=C1OC(=O)C2C1C1C(=O)OC(=O)C21 ; O=C1CC2C3CC(C(=O)OC3=O)C2C(=O)O1]

An aromatic diamine based monomer may be a monomer having a structure expressed below in Formula 4 on a diamine basis.

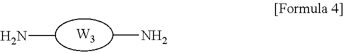

Here, W₃ may be derived from one of Formula 4-1 to Formula 4-3.

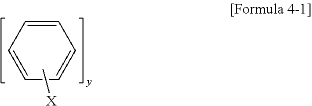

Here, X is an alkyl group and y is an integer of 1 to 3.

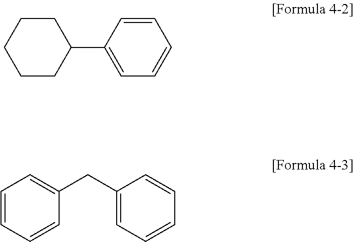

An aliphatic ring substituted aromatic diamine based monomer may be a monomer expressed by Formula 5 on a diamine basis.

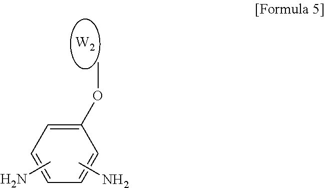

Here, W₂ may be derived from one of Formula 5-1 and Formula 5-2.

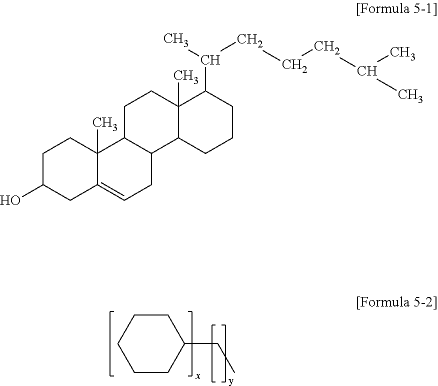

Here, x is a natural number of 1 to 5, and y is a natural number of 1 to 10.

A photo-reactive diamine based monomer is a monomer including a reactive mesogen (RM) on a diamine basis. The photo-reactive diamine based monomer may be a monomer having the structure expressed as Formula 6, and in detail, it may be a monomer having the structure of Formula 6-1.

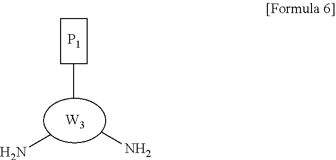

Here, P₁ is a reactive mesogen, and W₃ is an aromatic ring and may be derived from one of Formula 4-1 to Formula 4-3.

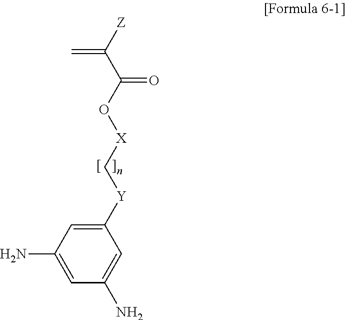

Here, X may be methylene (CH₂), phenylene (C₆H₄), biphenylene (C₁₂H₈), cyclohexylene (C₆H₈), bicyclohexylene (C₁₂H₁₆), or phenyl-cyclohexylene (C₆H₄—C₆H₈), Y may be methylene (CH₂), ether (—O—), ester (—O—C═O— or —O═C—O—), phenylene (C₆H₄), or cyclohexylene (C₆H₈), and Z may be methyl (CH₃) or hydrogen (H). Further, n may be an integer of 1 to 10.

An alkylated aromatic diamine based monomer may be a monomer expressed in Formula 7 on a diamine basis.

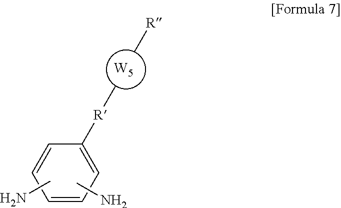

Here, R′ is —(CH₂)ₙ—, —O—(CH₂)ₙ—, —(O—C═O), or —(O═C—O)—(CH₂)ₙ—, R″ is —(CH₂)ₙ—I—CH₃, —O—(CH₂)ₙ₋₁—CH₃, —(O—C═O), or (O═C—O)—(CH₂)ₙ₋₁—CH₃, and n is one of 1 to 10.

Further, W₅ may be derived from Formula 7-1.

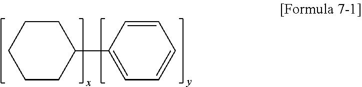

Here, x and y are independently an integer of 1 to 3.

A liquid crystal layer 3 is provided between the lower panel 100 and the upper panel 200. The liquid crystal layer 3 includes a plurality of liquid crystal molecules 310.

In an exemplary embodiment, the liquid crystal layer 3 may include liquid crystal molecules having a single alkenyl group. The liquid crystal molecules have low viscosity so as to improve a response speed in the liquid crystal display. An example of the liquid crystal molecules having a single alkenyl group may include at least one of Formula 8-1 to Formula 8-16, but the liquid crystal molecules including an alkenyl group are not restricted thereto.

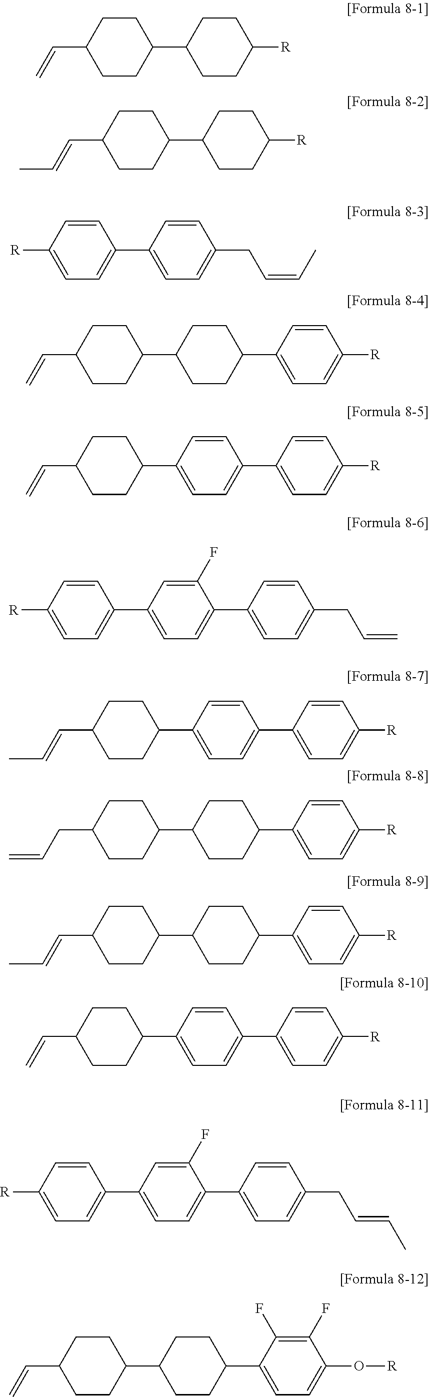

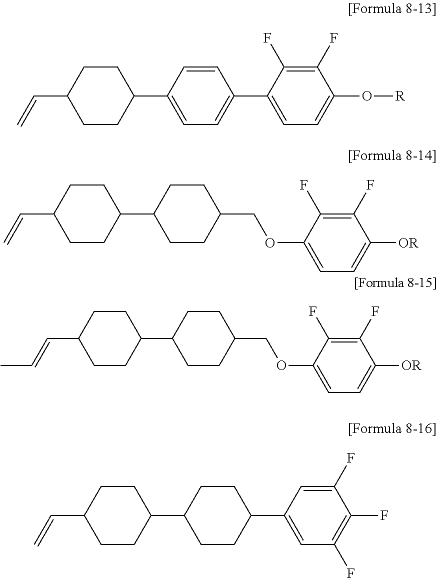

Here, each R is independently a C1 to C5 alkyl group.

The liquid crystal molecules having a single alkenyl group have low viscosity and perform an important role in improving the response speed of the liquid crystal display. However, the liquid crystal molecules may deteriorate and thus affect reliability. For example, an alkenyl by-product may be detected and a linear afterimage may be generated when an electric field exposure process and a fluorescent exposure process are performed during the formation of alignment layers 11 and 21.

Therefore, in an exemplary embodiment, the photostabilizer expressed in Formula 1 or Formula 2 is included in the alignment layers 11 and 21 to control generation of the alkenyl by-product and minimize the afterimage that may be generated in the display device.

The upper panel 200 will now be described.

A common electrode 270 is formed on a transparent insulation substrate 210 on the upper panel 200.

A second alignment layer 21 is formed inside the upper panel 200, and the second alignment layer 21 may be a vertical alignment layer. The second alignment layer 21 includes a second alignment polymer 23a formed by irradiating light onto an alignment aid. The alignment aid may be a reactive mesogen and the second alignment layer 21 may be formed as described above with regard to the first alignment layer 11, so no repeated description will be provided.

A spacer 363 for maintaining a gap between the upper panel 200 and the lower panel 100 is formed.

A polarizer (not shown) may be provided outside the lower panel 100 and the upper panel 200.

When a voltage is applied to the pixel electrode 191 and the common electrode 270, the liquid crystal molecules 310 respond to the electric field formed between the pixel electrode 191 and the common electrode 270 such that their long axes change direction to become perpendicular to the direction of the electric field. A change in the degree of polarization of light incident to the liquid crystal layer 3 is determined by an inclined degree of the liquid crystal molecules 310. The change in light polarization is shown as a change of transmittance by the polarizer, and the liquid crystal display displays an image according to the change of transmittance.

The direction in which the liquid crystal molecules 310 are inclined is determined by the fine branches 194 of the pixel electrode 191, and the liquid crystal molecules 310 are inclined at a direction in parallel with a length direction of the fine branch 194. Since one pixel electrode 191 includes four subregions with different length directions of the fine branch 194, the liquid crystal molecules 310 are inclined in substantially four directions and to as a result, four domains with different alignment directions of the liquid crystal molecules 310 are formed on the liquid crystal layer 3. By varying the directions in which the liquid crystal molecules are inclined, a viewing angle of the liquid crystal display may be improved.

In an exemplary embodiment, the liquid crystal display allows the alignment polymers 13a and 23a, formed by polymerizing the alignment aid, to control a pre-tilt that is an initial alignment direction, of the liquid crystal molecules 310.

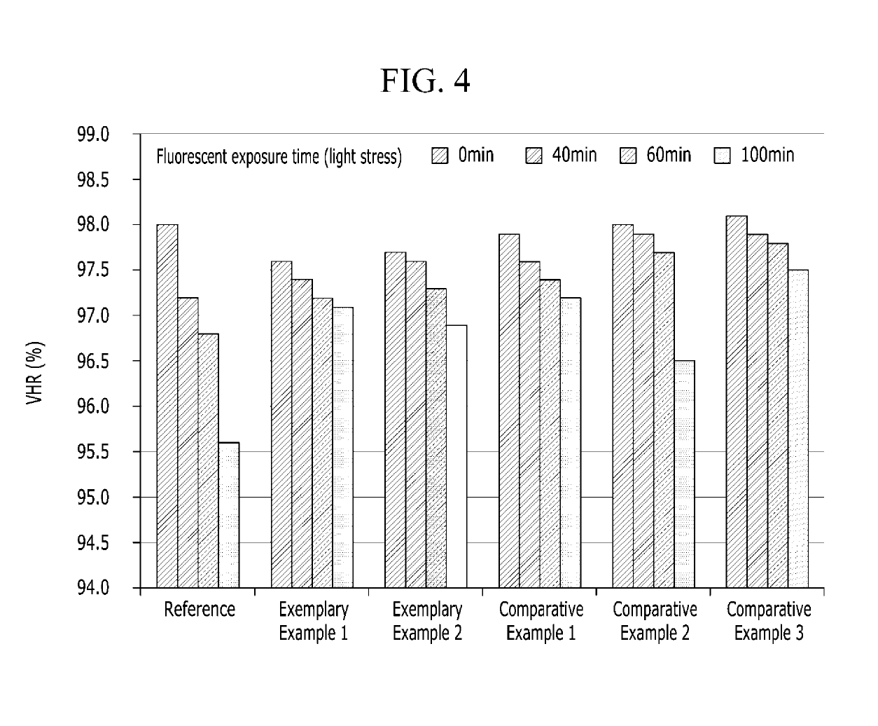

An experimental result acquired by measuring a voltage holding ratio of the liquid crystal display to which an exemplary embodiment of an alignment layer is applied will now be described with reference to FIG. 4.

FIG. 4 shows a graph illustrating the variation in voltage holding ratio (VHR) with the fluorescent exposure time (0, 40, 60, 100 min) for the Exemplary Examples of a liquid crystal display (Examples 1 and 2) and the Comparative Examples (Comparative Examples 1 to 3). The Examples and a Comparative Examples are use in a liquid crystal display to which a liquid crystal layer including a single alkenyl is applied.

Referring to FIG. 4, the vertical axis represents the voltage holding ratio (VHR). The horizontal axis indicates a liquid crystal display to which an alignment layer including various photostabilizers shown in Table 1 is applied.

TABLE 1

| Horizontal Axis | Added Photostabilizer |
|---|---|
| Reference | Photostabilizer Not Included |
| Exemplary Example 1 | 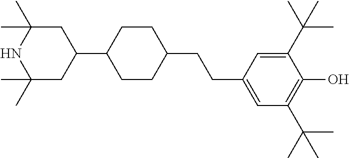 [SMILES: CC1(C)CC(C2CCC(CCc3cc(C(C)(C)C)c(O)c(C(C)(C)C)c3)CC2)CC(C)(C)N1] |
| | [Formula 1-15] |
| Exemplary Example 2 | 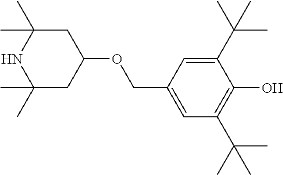 [SMILES: CC1(C)CC(OCc2cc(C(C)(C)C)c(O)c(C(C)(C)C)c2)CC(C)(C)N1] |
| | [Formula 1-1] |
| Comparative Example 1 | 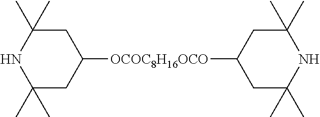 |
| | [Formula 9] |
| Comparative Example 2 | 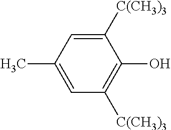 [SMILES: Cc1cc(C(C)(C)C)c(O)c(C(C)(C)C)c1] |
| | [Formula 10] |
| Comparative Example 3 | 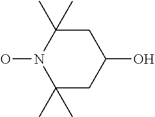 |
| | [Formula 11] |

Comparative Examples 1 to 3 include photostabilizers that are conventionally used to improve afterimage. Referring to FIG. 4, Comparative Example 1 to Comparative Example 3 show an excellent voltage holding ratio with respect to fluorescent exposure time in comparison to the Reference case in which an alignment layer to which no photostabilizer is added is used.

Further, it is shown that Exemplary Example 1 and Exemplary Example 2 including the exemplary photostabilizers disclosed herein have the similar or excellent voltage holding ratio compared to the existing photostabilizer of Comparative Example 1 to Comparative Example 3.

Therefore, it is determined that the exemplary photostabilizers may improve the voltage holding ratio in a liquid crystal display including a liquid crystal molecules including a single alkenyl group.

As described, regarding exemplary embodiments of the alignment layer and the liquid crystal display including the same, the alignment layer includes a new photostabilizer to prevent generation of an impurity that may occur from the liquid crystal composition and improve the afterimage generated from the display panel. Further, the reliability is also improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An alignment layer comprising at least one of photostabilizers expressed by Formula 1 and Formula 2: 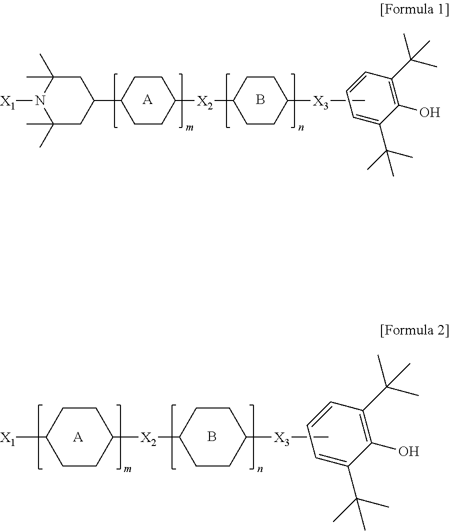
wherein X₁ is H, —OH, —OR, or R, X₂ is a bond, —O—, —OCO—, —OR—, —RO—, —NOR—, or R, X₃ is —O—, —OCO—, —OR—, —RO—, —NOR—, or R, each A and B are independently a cyclo-hexyl group, a cyclic ether group, or a phenyl group, each R is independently a C1 to C5 alkyl group, and each m and n are independently a natural number of 0 to 2.

2. The alignment layer of claim 1, wherein
the photostabilizer expressed by Formula 1 comprises at least one of compounds expressed by Formula 1-1 to Formula 1-28: 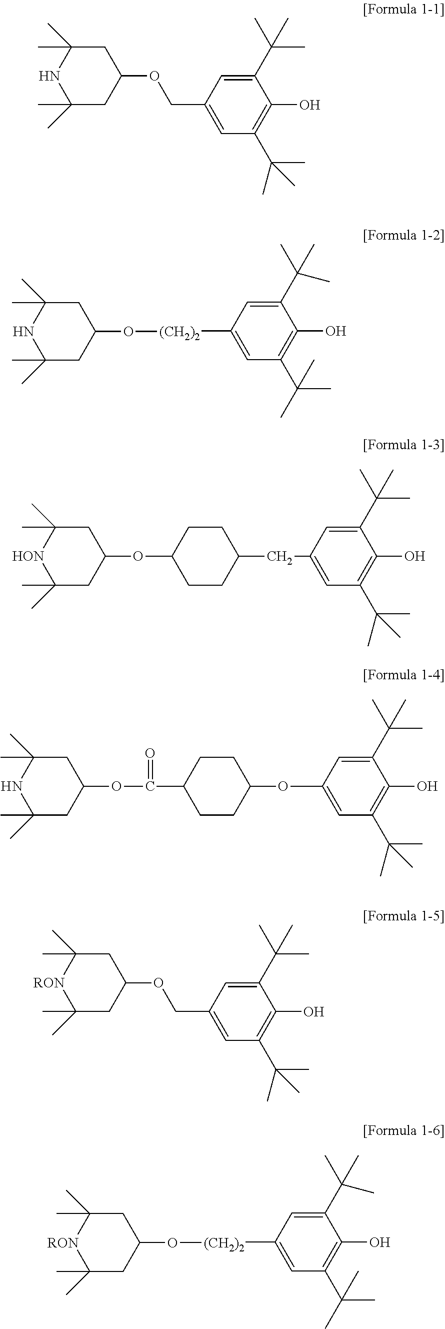 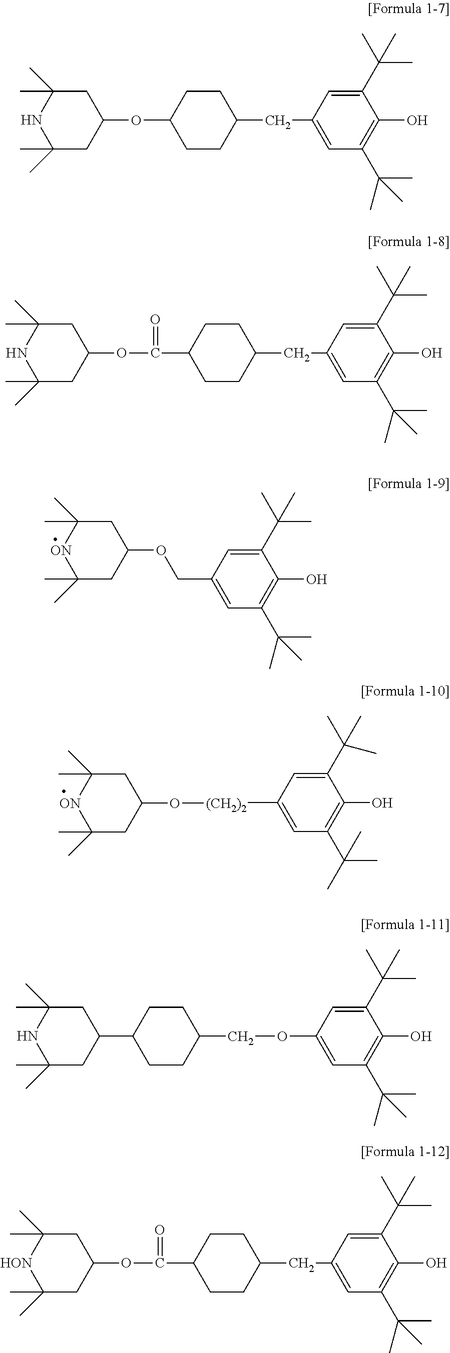 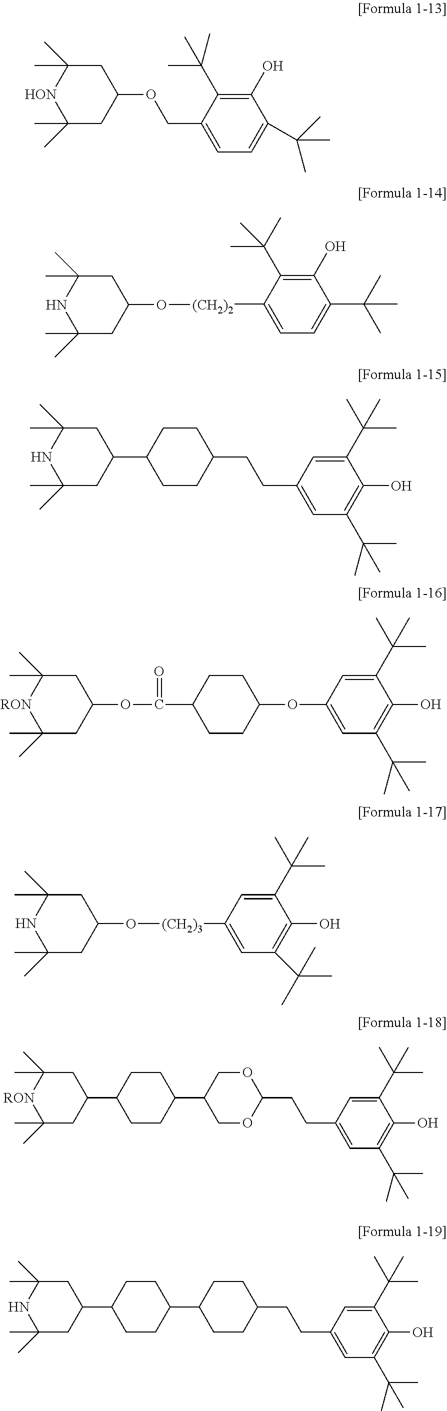 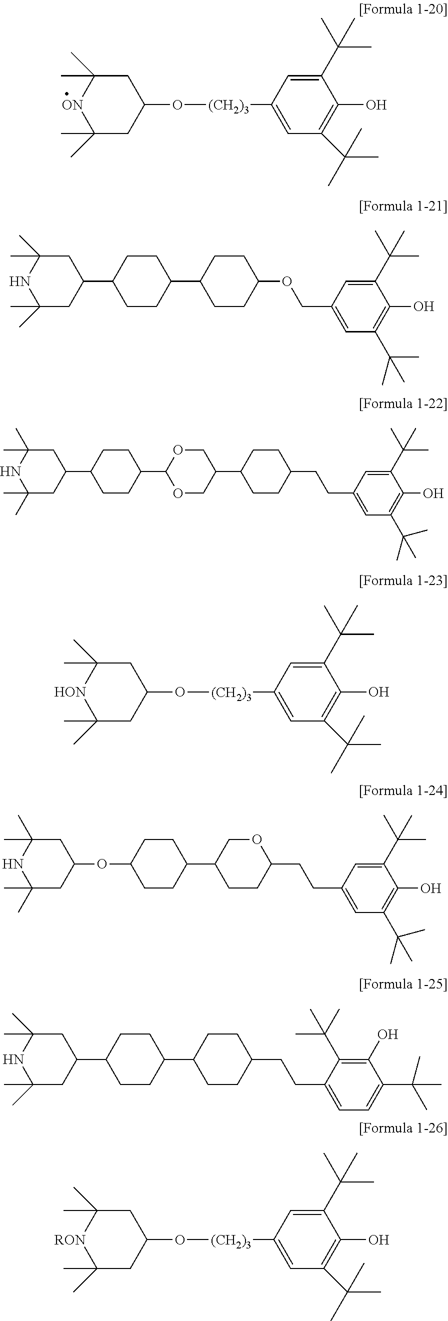 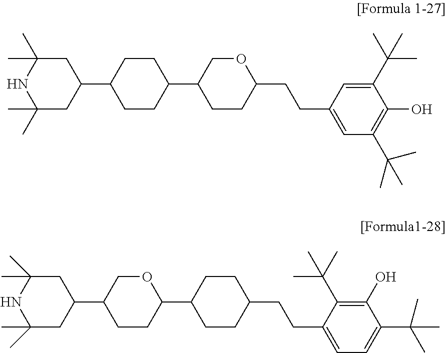
wherein each R is independently a C1 to C5 alkyl group.

3. The alignment layer of claim 1, wherein
the photostabilizer expressed by Formula 2 comprises at least one compound expressed by Formula 2-1 to Formula 2-16: 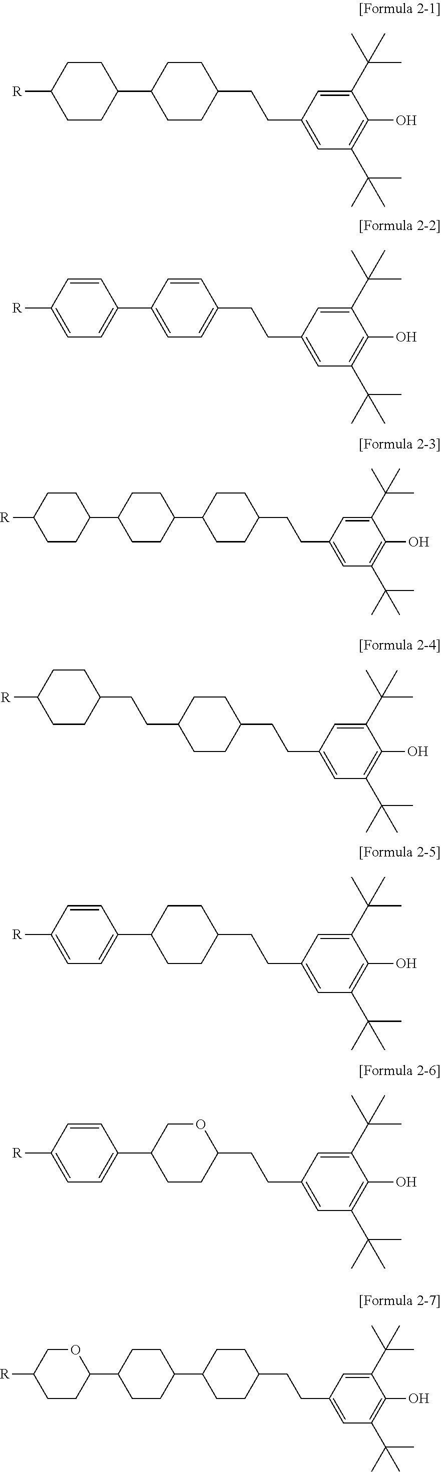 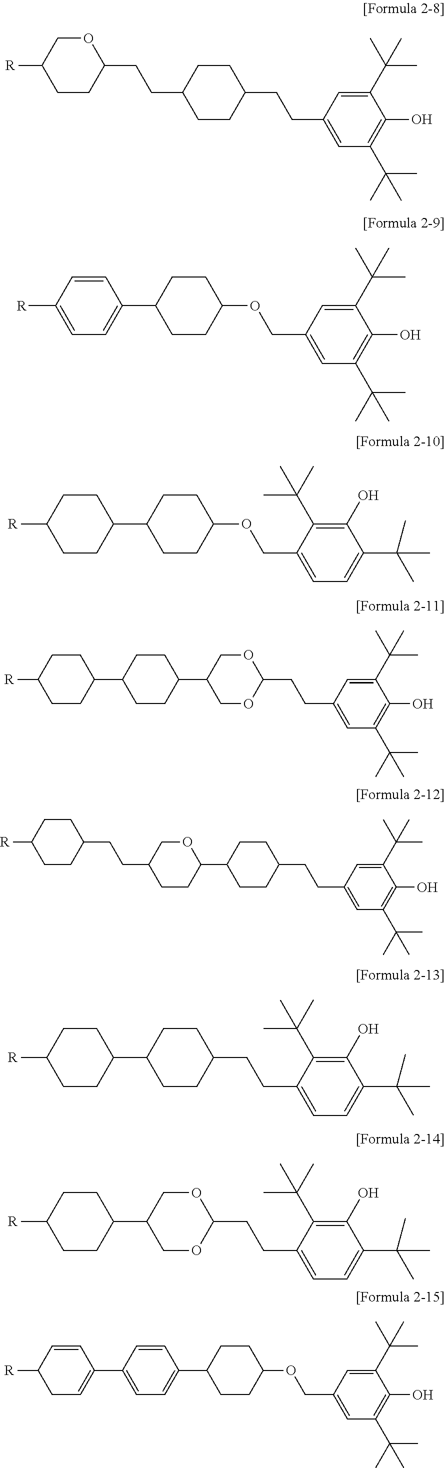 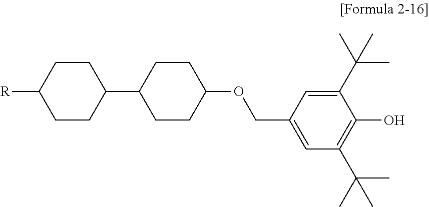
wherein each R is independently a C1 to C5 alkyl group.

4. The alignment layer of claim 1, wherein
the alignment layer further comprises:
a first material including a dianhydride based monomer; and
a second material including a diamine based monomer.

5. The alignment layer of claim 4, wherein
the photostabilizer is bound to the diamine based monomer.

6. The alignment layer of claim 4, wherein
the first material comprises an alicyclic dianhydride based monomer, and
the second material comprises at least one of an aromatic diamine based monomer, an aliphatic ring substituted aromatic diamine based monomer, a photoreactive diamine based monomer, and an alkylated aromatic diamine based monomer.

7. The alignment layer of claim 6, wherein
the alicyclic dianhydride based monomer comprises at least one of monomers expressed by Formula 3-1 to Formula 3-5:

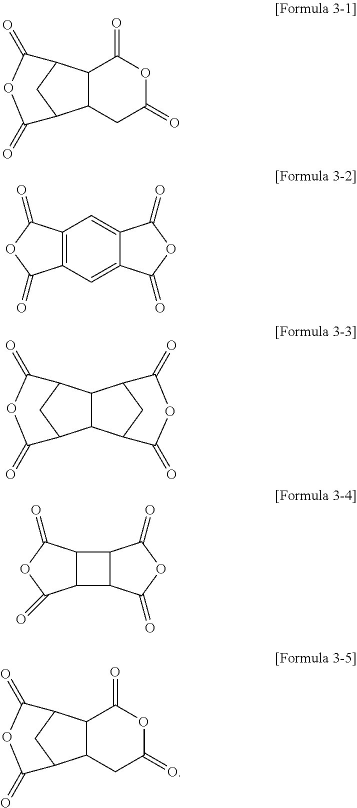

8. A liquid crystal display comprising:
a first substrate;
a second substrate facing the first substrate;
an electric field generating electrode disposed on at least one of the first substrate and the second substrate;
a first alignment layer disposed on the first substrate and a second alignment layer disposed on the second substrate; and
a liquid crystal layer comprising a plurality of liquid crystal molecules and disposed between the first substrate and the second substrate,
wherein at least one of the first alignment layer and the second alignment layer comprises at least one of photostabilizers expressed by Formula 1 and Formula 2: 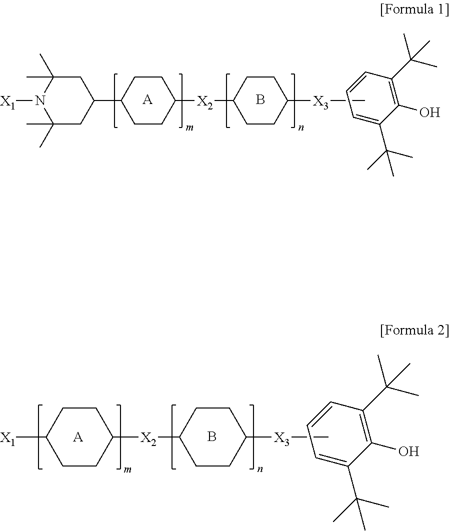
where X₁ is one of H, —O, —OH, —OR, and R, X₂ is a bond, —O—, —OCO—, —OR—, —RO—, —NOR—, or R, X₃ is —O—, —OCO—, —OR—, —RO—, —NOR—, or R, each A and B are independently a cyclo-hexyl group, a cyclic ether group, or a phenyl group, each R is independently a C1 to C5 alkyl group, and each m and n are independently a natural number of 0 to 2.

9. The liquid crystal display of claim 8, wherein
the liquid crystal molecules comprise an alkenyl group.

10. The liquid crystal display of claim 9, wherein
the liquid crystal molecules comprise at least one of compounds expressed by Formula 8-1 to Formula 8-16: 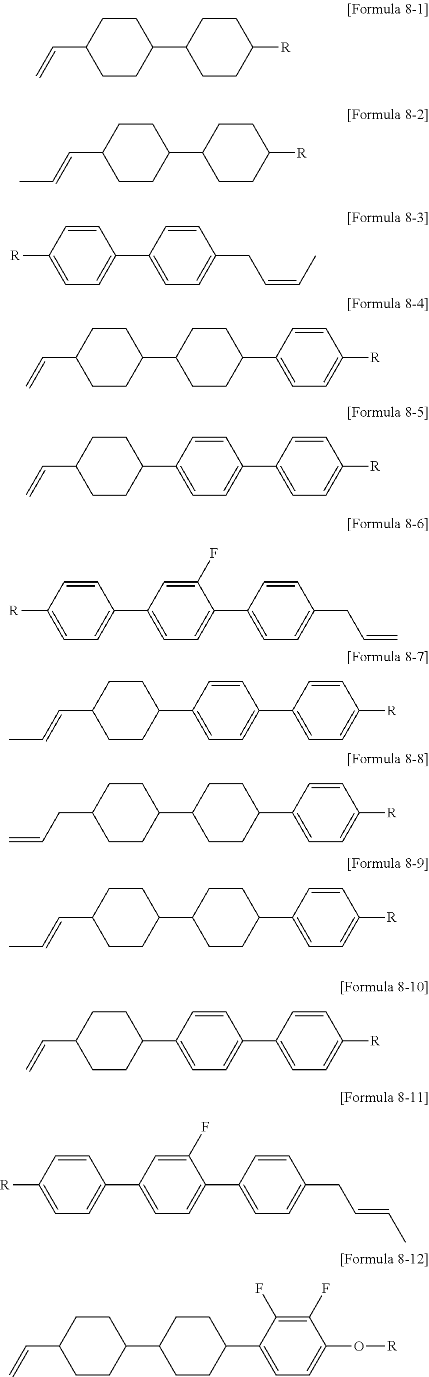 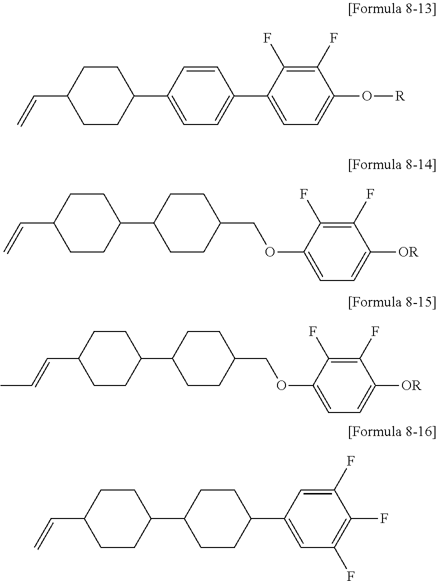
wherein each R is independently a C1 to C5 alkyl group.

11. The liquid crystal display of claim 9, wherein
the photostabilizer expressed by Formula 1 comprises at least one of compounds expressed by Formula 1-1 to Formula 1-28: 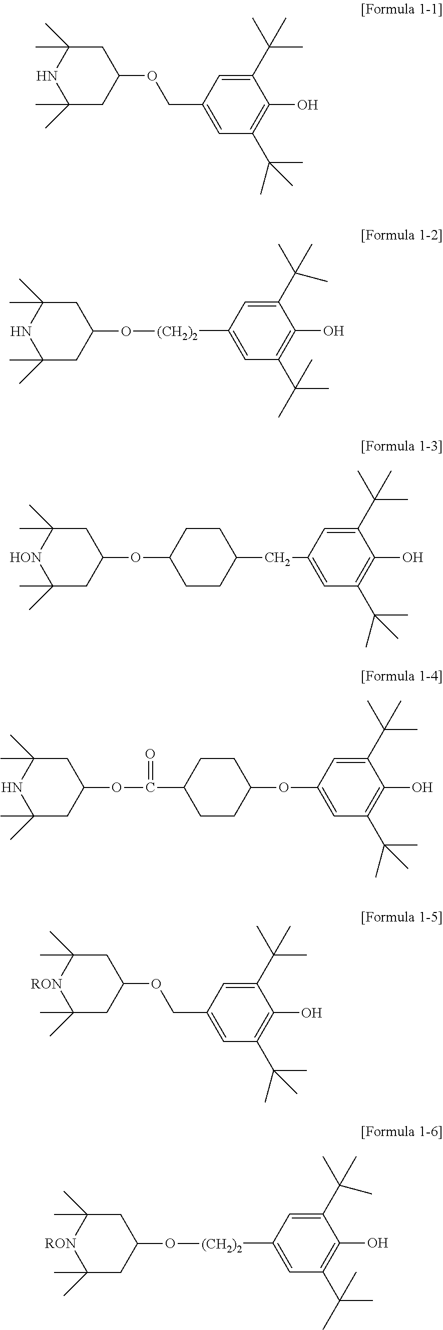 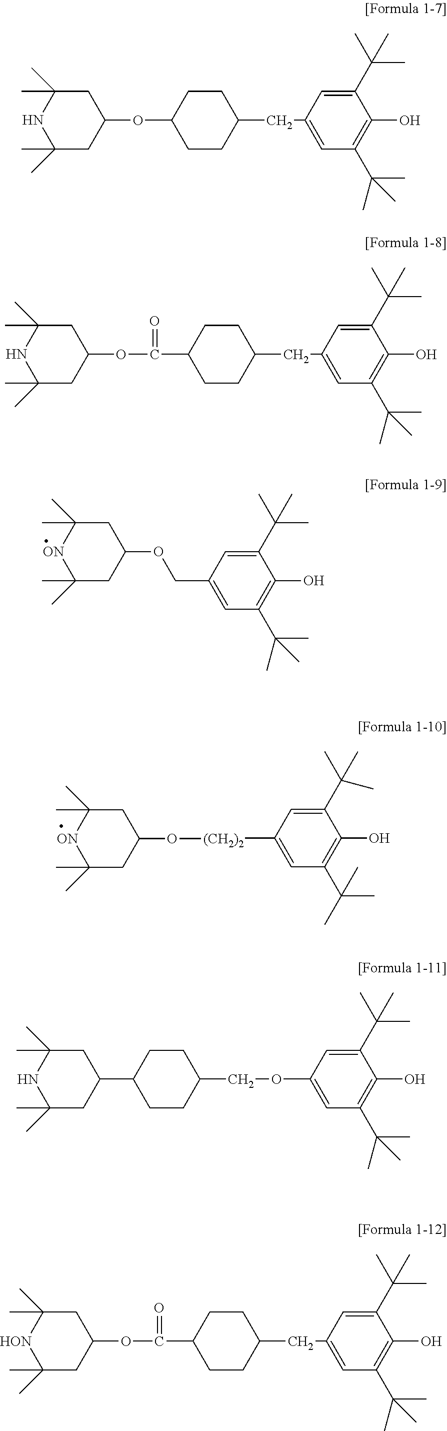 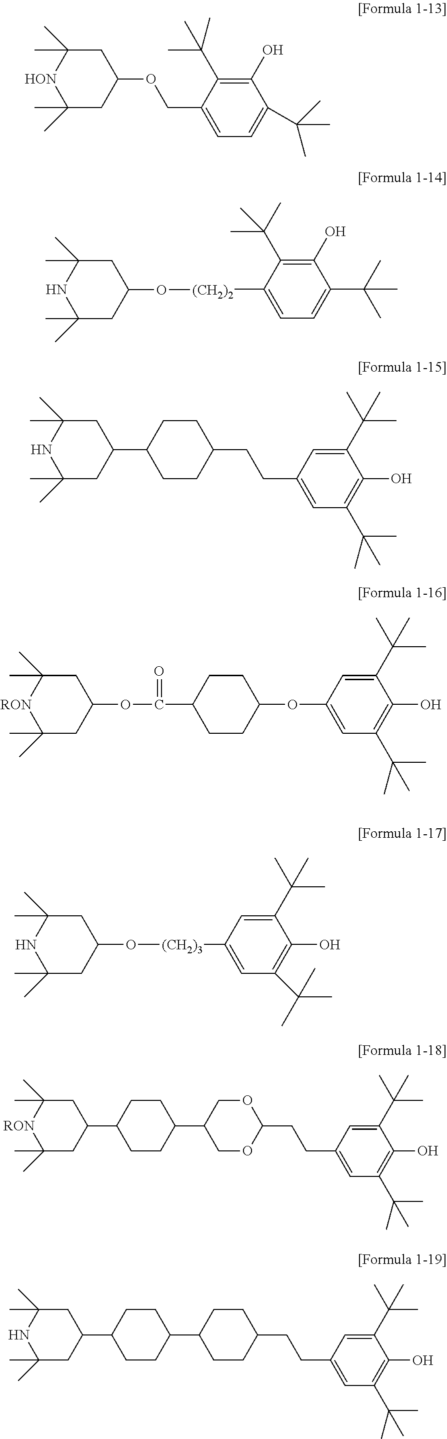 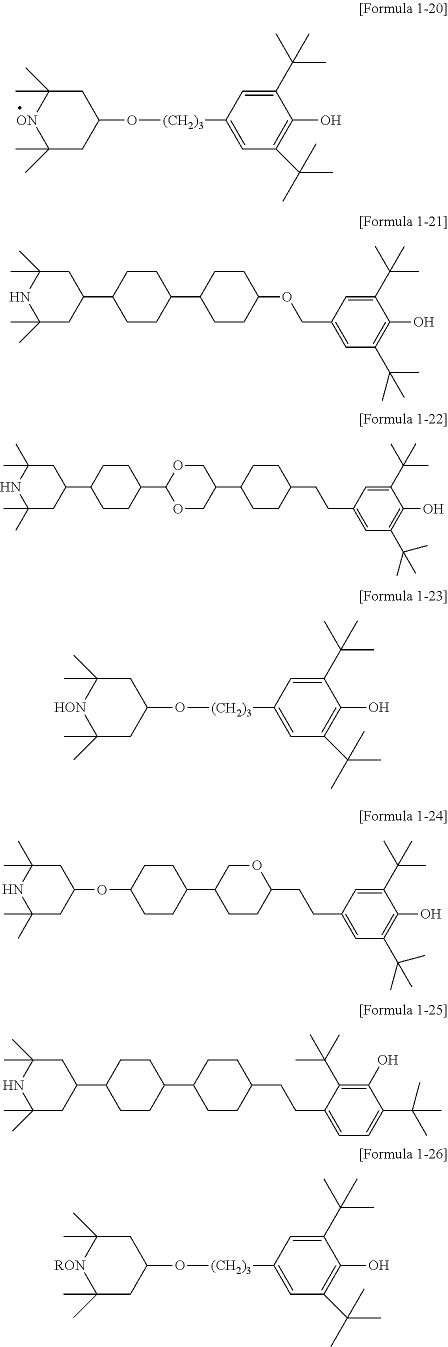 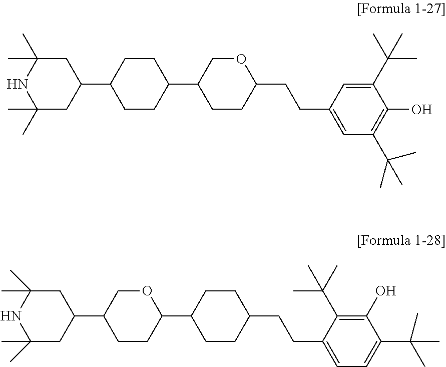
wherein each R is independently a C1 to C5 alkyl group.

12. The liquid crystal display of claim 9, wherein
the photostabilizer expressed by Formula 2 comprises at least one of compounds expressed by Formula 2-1 to Formula 2-16: 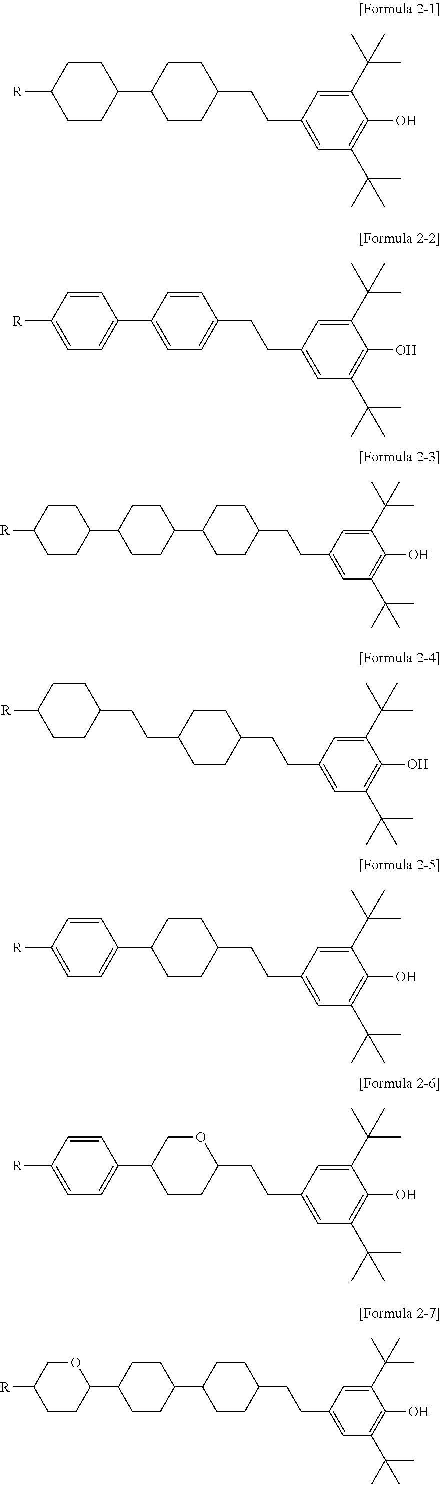 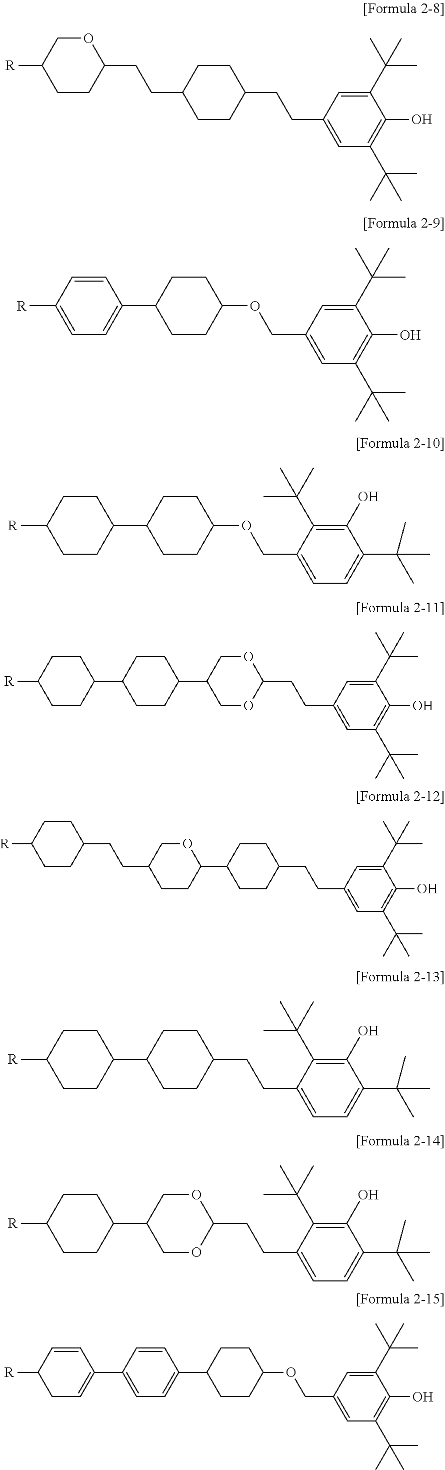 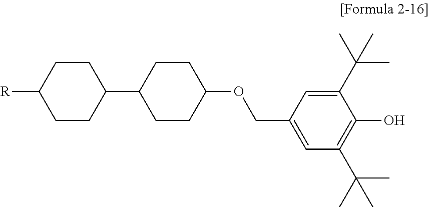
wherein each R is independently a C1 to C5 alkyl group.

13. The liquid crystal display of claim 9, wherein
the alignment layer further comprises:
a first material comprising a dianhydride based monomer; and
a second material comprising a diamine based monomer.

14. The liquid crystal display of claim 13, wherein
the photostabilizer is bound to the diamine based monomer.

15. The liquid crystal display of claim 13, wherein
the first material comprises an alicyclic dianhydride based monomer, and
the second material comprises at least one of an aromatic diamine based monomer, an aliphatic ring substituted aromatic diamine based monomer, a photoreactive diamine based monomer, and an alkylated aromatic diamine based monomer.

16. The liquid crystal display of claim 15, wherein
the alicyclic dianhydride based monomer comprises at least one of monomers expressed by Formula 3-1 to Formula 3-5: 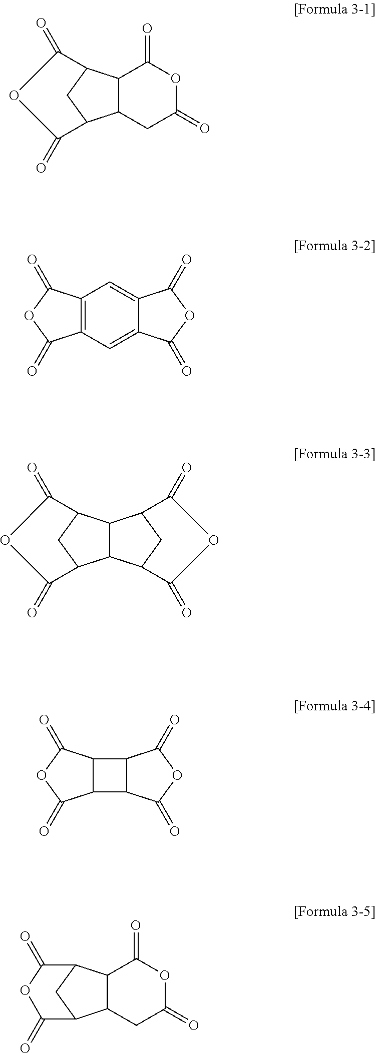 [SMILES: O=C1CC2C3CC(C(=O)OC3=O)C2C(=O)O1 ; O=c1oc(=O)c2cc3c(=O)oc(=O)c3cc12 ; O=C1OC(=O)C2CC1C1C3CC(C(=O)OC3=O)C21 ; O=C1OC(=O)C2C1C1C(=O)OC(=O)C21 ; O=C1CC2C3CC(C(=O)OC3=O)C2C(=O)O1]
